(19) United States
(12) Patent Application Publication
(10) Pub. No.: US 2025/0162827 A1
(43) Pub. Date: May 22, 2025

(54) SHEET SEPARATION DEVICE, SHEET LAMINATOR, AND IMAGE FORMING SYSTEM

(71) Applicants: Hirofumi HORITA, Kanagawa (JP); Satoshi KUNO, Kanagawa (JP); Takaya OCHIAI, Kanagawa (JP)

(72) Inventors: Hirofumi HORITA, Kanagawa (JP); Satoshi KUNO, Kanagawa (JP); Takaya OCHIAI, Kanagawa (JP)

(73) Assignee: Ricoh Company, Ltd., Tokyo (JP)

(21) Appl. No.: 18/941,449

(22) Filed: Nov. 8, 2024

(30) Foreign Application Priority Data
Nov. 22, 2023 (JP) 2023-197989

(51) Int. Cl. B65H 3/06; B32B 37/00; B32B 37/14

(52) U.S. Cl. CPC B65H 3/06; B32B 37/0053; B32B 37/142; B32B 2037/0061; B65H 2801/27

(57) ABSTRACT

A sheet separation device includes a sheet separation unit, a conveyance roller pair, branched conveyance passages, and a movable conveyance guide. The sheet separation unit includes a winding roller and a separator. The winding roller rotates in a given rotational direction to wind a two-ply sheet having two sheets. The separator separates a non-bonding portion of the two-ply sheet. The sheet separation unit inserts an inner sheet between the two sheets separated from each other. The conveyance roller pair conveys the two-ply sheet in a first direction and a second direction opposite to the first direction. The branched conveyance passages are disposed between the winding roller and the conveyance roller pair. The movable conveyance guide is movable in the first and second directions to guide the two-ply sheet or the inner sheet. The separator is disposed between the winding roller and the conveyance roller pair.

### CROSS-REFERENCE TO RELATED APPLICATION

This patent application is based on and claims priority pursuant to 35 U.S.C. § 119 (a) to Japanese Patent Application No. 2023-197989, filed on Nov. 22, 2023, in the Japan Patent Office, the entire disclosure of which is hereby incorporated by reference herein.

### BACKGROUND

### Technical Field

Embodiments of the present disclosure relate to a sheet separation device to separate the non-bonding portion of a two-ply sheet in which two sheets are overlapped and bonded together at a bonding portion of the two-ply sheet, a sheet laminator including the sheet separation device, and an image forming system including an image forming apparatus such as a copier, a printer, a facsimile machine, and a multi-functional apparatus having at least two functions of the copier, the printer, and the facsimile machine.

### Background Art

Various types of sheet separation devices in the related art are known to separate a two-ply sheet in which two sheets are overlapped and bonded together at one ends as a bonding portion and insert an inner sheet between the two sheets separated from each other.

Specifically, a sheet separation device in the related art includes a sheet separator including a winding roller and a separation member. The sheet separator of the sheet separation device separates two sheets of a laminated sheet (e.g., a two-ply sheet) in which one sides of the two sheets are bonded at one end of the laminated sheet. At this time, the two-ply sheet is conveyed in the normal direction from a winding roller to a conveyance roller pair or is conveyed in the reverse direction opposite to the normal direction from the conveyance roller pair to the winding roller. Then, an inner sheet (insertion sheet) is conveyed in the normal direction to a portion between the two sheets separated and branched in two branched conveyance passages over a conveyance passage between the winding roller and the conveyance roller pair, so that the inner sheet is inserted to the two-ply sheet.

### SUMMARY

Embodiments of the present disclosure described herein provide a novel sheet separation device including a sheet separation unit, a conveyance roller pair, branched conveyance passages, and a movable conveyance guide. The sheet separation unit includes a winding roller and a separator. The winding roller rotates in a given rotational direction to wind a two-ply sheet having two sheets overlapped and bonded together at a bonding portion. The separator separates a non-bonding portion of the two-ply sheet. The sheet separation unit inserts an inner sheet between the two sheets separated from each other. The conveyance roller pair conveys the two-ply sheet from the sheet separation unit along a conveyance passage in a first direction, and conveys the two-ply sheet toward the sheet separation unit along the conveyance passage in a second direction opposite to the first direction. The branched conveyance passages are branched from the conveyance passage in separate directions, and disposed between the winding roller and the conveyance roller pair across the conveyance passage. The movable conveyance guide is movable in the first direction and the second direction in the conveyance passage to guide the two-ply sheet or the inner sheet. The separator is disposed between the winding roller and the conveyance roller pair in the conveyance passage.

Further, embodiments of the present disclosure described herein provide a sheet laminator including the above-described sheet separation device, and a sheet lamination unit to perform a sheet laminating operation on the two-ply sheet having the inner sheet inserted between the two sheets separated by the sheet separation device.

Further, embodiments of the present disclosure described herein provide an image forming system including the above-described sheet laminator, and an image forming apparatus to form an image on the inner sheet.

Further, embodiments of the present disclosure described herein provide an image forming system including the above-described sheet separation device, and an image forming apparatus to form an image on the inner sheet.

### BRIEF DESCRIPTION OF THE SEVERAL VIEWS OF THE DRAWINGS

Exemplary embodiments of this disclosure will be described in detail based on the following figures, wherein:

FIG. 1 is a schematic diagram illustrating an overall configuration of a sheet separation device according to an embodiment of the present disclosure;

FIG. 2A is a side view of a gripper that has moved to a gripping position in a sheet separator illustrated in FIG. 1;

FIG. 2B is a side view of the gripper that has moved to a releasing position in the sheet separator illustrated in FIG. 1;

FIG. 3A is a perspective view of the gripper that has moved to the gripping position in the sheet separator illustrated in FIG. 1;

FIG. 3B is a perspective view of the gripper that has moved to the releasing position in the sheet separator illustrated in FIG. 1;

FIG. 4 is a block diagram illustrating a hardware configuration of the control block of the sheet separation device of FIG. 2 to control the operation of the sheet separation device;

FIGS. 5A, 5B, 5C, and 5D are schematic views of the sheet separation device, each illustrating a sheet separating operation performed in the sheet separation device illustrated in FIG. 1;

FIGS. 6A, 6B, 6B′, 6C, 6C′, and 6D are schematic views of the sheet separation device, each illustrating the sheet separating operation performed in the sheet separation device, subsequent from the sheet separating operation of FIGS. 5A, 5B, 5C, and 5D;

FIGS. 7A, 7B, and 7C are schematic views of the sheet separation device, each illustrating the sheet separating operation performed in the sheet separation device, subsequent from the sheet separating operation of FIGS. 6A, 6B, 6B′, 6C, 6C′, and 6D;

FIGS. 8A, 8B, and 8C are schematic views of the sheet separation device, each illustrating the sheet separating operation performed in the sheet separation device, subsequent from the sheet separating operation of FIGS. 7A, 7B, and 7C;

FIGS. 9A, 9B, and 9C are schematic views of the sheet separation device, each illustrating the sheet separating operation performed in the sheet separation device, subsequent from the sheet separating operation of FIGS. 8A, 8B, and 8C;

FIG. 10 is a schematic view of separation members inserted into a two-ply sheet in a width direction of the two-ply sheet;

FIGS. 11A, 11B, and 11C are perspective views of the separation members, each illustrating the operations of the separation members in the width direction;

FIGS. 12A and 12B are schematic view of a driving mechanism that moves the separation members;

FIG. 13 including FIGS. 13A and 13B is a flowchart of the control process executed in the sheet separation device;

FIG. 14 is a flowchart of the control process of a movable conveyance guide plate executed in the sheet separation device;

FIG. 15 is a perspective view of a movable conveyance guide plate and a guide member driving mechanism;

FIG. 16 is a schematic view of a sheet laminator, according to Modification 1 of an embodiment of the present disclosure;

FIG. 17 is a diagram illustrating an image forming system according to Modification 2 of an embodiment of the present disclosure;

FIG. 18 is a diagram illustrating an image forming system according to Modification 3 of an embodiment of the present disclosure;

FIG. 19A is a diagram illustrating an image forming system, according to another embodiment of the present disclosure; and

FIG. 19B is a diagram illustrating an image forming system, according to yet another embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Identical reference numerals are assigned to identical or equivalent components and a description of those components may be simplified or omitted.

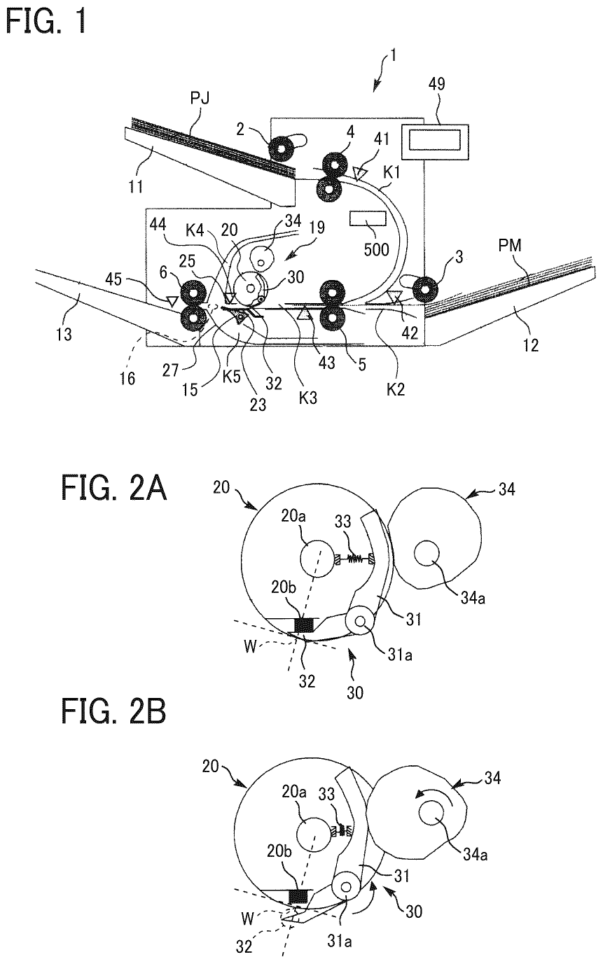

A description is given of the overall configuration and operations of a sheet separation device 1, with reference to FIG. 1.

FIG. 1 is a schematic diagram illustrating an overall configuration of the sheet separation device 1 according to an embodiment of the present disclosure.

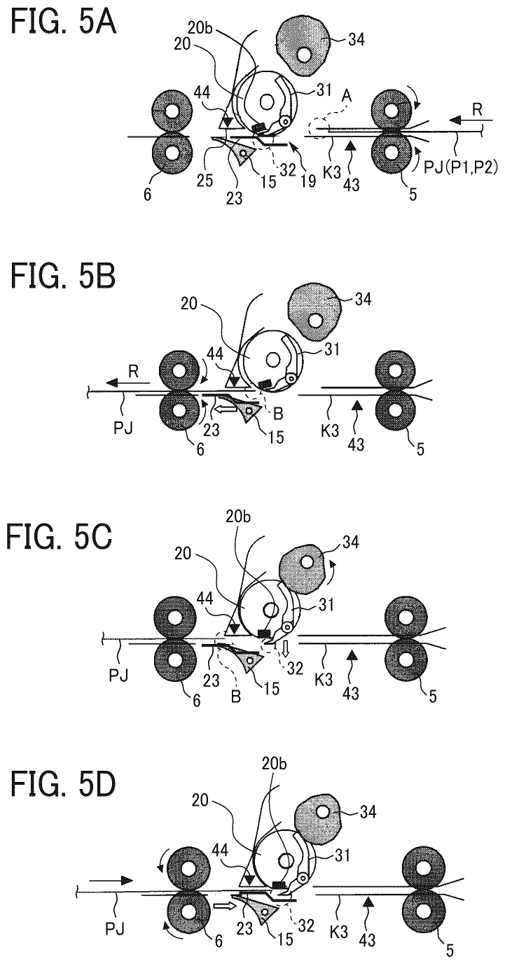

The sheet separation device 1 includes a sheet separation unit 19 that separates the non-bonding portion of a two-ply sheet PJ in which two sheets, which are a first sheet P1 and a second sheet P2, are overlapped and bonded together at a bonding portion A of the two-ply sheet PJ (see FIG. 5A).

The sheet separation unit 19 performs the sheet separating operation and the sheet inserting operation. To be more specific, the sheet separation unit 19 performs the sheet separating operation to separate the non-bonding portion of the two-ply sheet PJ. The sheet separation unit 19 then performs the sheet inserting operation to insert the inner sheet PM between the first sheet P1 and the second sheet P2 separated from each other in the sheet separating operation.

Specifically, as illustrated in FIG. 1, the sheet separation device 1 includes the operation display panel 49 that functions as an operation display on the exterior of the sheet separation device 1. The operation display panel 49 (operation display unit) is to display various kinds of information about the sheet separation device 1 or is to accept inputs of various kinds of commands by the user.

In particular, in the present embodiment, the two-ply sheet PJ includes the first sheet P1 and the second sheet P2 overlapped and bonded together at one sides of the four sides as the bonding portion A. In other words, in the two-ply sheet PJ including the first sheet P1 and the second sheet P2, one side (the bonding portion A) of the first sheet P1 and one side (the bonding portion A) of the second sheet P2 are bonded (attached) by, e.g., thermal welding, and the other side of the first sheet P1 and the other side of the second sheet P2 are not bonded (attached). As the first sheet P1 and the second sheet P2 of the two-ply sheet PJ, a transparent film sheet (that is, a lamination sheet) may be employed.

The two-ply sheet PJ may be made by folding a single sheet. In the present disclosure, the two-ply sheet PJ made by folding a single sheet is also defined as the two sheets overlapped, a folded portion of the folded single sheet is defined as the bonding portion, and the other portions are defined as the non-bonding portions.

The sheet separation unit 19 separates the non-bonding portion of the two sheets P1 and P2 of the two-ply sheet PJ between a winding roller 20 and the third conveyance roller pair 6 (conveyance roller pair), in other words, separates the two sheets P1 and P2 of the two-ply sheet PJ around the bonding portion A that maintains bonding of the first sheet P1 and the second sheet P2. Subsequently, the sheet separation device 1 (the sheet separation unit 19) performs an operation in which the inner sheet PM is inserted between the separated two sheets, which are the first sheet P1 and the second sheet P2 of the two-ply sheet PJ. The inner sheet PM is a sheet such as one plain sheet.

As illustrated in FIG. 1, the sheet separation device 1 includes the sheet separation unit 19, a first sheet tray 11, a second sheet tray 12, a first feed roller 2, a second feed roller 3, a first conveyance roller pair 4, a second conveyance roller pair 5, a third conveyance roller pair 6, an ejection tray 13, a first sensor 41, a second sensor 42, a third sensor 43, a fourth sensor 44, a fifth sensor 45, a first guide 25 as an inner restrictor, a movable conveyance guide plate 23 (second guide) as a movable conveyance guide, and a third guide 27.

The sheet separation unit 19 further includes the winding roller 20, a movement mechanism 30, a switching member 15 as a switcher, and separation members 16 each as a separator.

The sheet separation device 1 further includes a plurality of sheet conveyance passages such as a first sheet conveyance passage K1 (curved conveyance passage), a second sheet conveyance passage K2, a third sheet conveyance passage K3, a first branched sheet conveyance passage K4, and a second branched sheet conveyance passage K5. Each of the first sheet conveyance passage K1, the second sheet conveyance passage K2, the third sheet conveyance passage K3, the first branched sheet conveyance passage K4, and the second branched sheet conveyance passage K5 includes two conveyance guides (guide plates) facing each other to guide and convey the sheet such as the two-ply sheet PJ or the inner sheet PM.

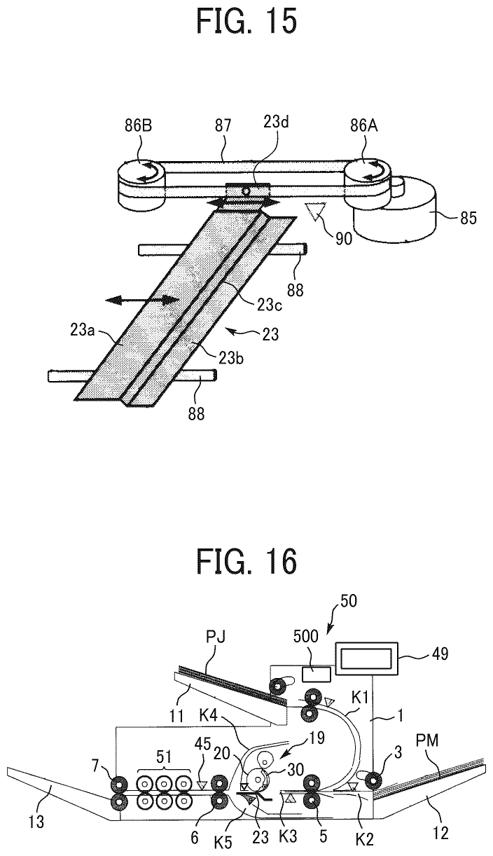

The movable conveyance guide plate 23 as a movable conveyance guide conveyance guide is slidable in the horizontal direction (the left-and-right direction in FIG. 1) by the driving of guide member driving mechanisms 85, 86A, 86B, 87, and 88 (see FIG. 15). The detailed description of the movable conveyance guide plate 23 will be given below.

To be more specific, two-ply sheets PJ are stacked on the first sheet tray 11. The first feed roller 2 feeds the uppermost two-ply sheet PJ on the first sheet tray 11 to the first conveyance roller pair 4, and the first conveyance roller pair 4 conveys the two-ply sheet PJ to the first sheet conveyance passage K1.

The inner sheets PM are stacked on the second sheet tray 12. Then, the second feed roller 3 feeds the uppermost inner sheet PM placed on top of the inner sheets PM on the second sheet tray 12.

Each of the first conveyance roller pair 4, the second conveyance roller pair 5, and the third conveyance roller pair 6 includes a drive roller and a driven roller each having an elastic layer made of, for example, rubber formed on a core, and conveys the sheet nipped by the respective nip regions formed by the drive roller and the driven roller. The third sheet conveyance passage K3 is a passage from the second conveyance roller pair 5 to the third conveyance roller pair 6 and disposed with the second conveyance roller pair 5, the winding roller 20, and the third conveyance roller pair 6 as a conveyance roller pair in this order from upstream to downstream in the sheet conveyance direction.

In particular, the third conveyance roller pair 6 is rotatable in forward to convey the sheet in the forward direction (normal direction) or in reverse to convey the sheet in the reverse direction. In other words, the third conveyance roller pair 6 functions as a conveyance roller pair that can convey a two-ply sheet PJ (I.e., the conveyance roller pair that nips and conveys the two-ply sheet PJ) in the forward and reverse directions, where the conveyance direction from the sheet separation unit 19 is the forward direction (normal direction) and the sheet conveyance direction to the sheet separation unit 19 is the reverse direction.

The third conveyance roller pair 6 also functions as an ejection roller pair that ejects the two-ply sheet PJ to the ejection tray 13.

Each of the first sensor 41, the second sensor 42, the third sensor 43, the fourth sensor 44, and the fifth sensor 45 functions as a sheet sensor employing a reflective photosensor that optically detects whether the sheet is present at the position of each sensor. The first sensor 41 is disposed at a position near the portion downstream from the first conveyance roller pair 4 in the sheet conveyance direction. The second sensor 42 is disposed at the position near a portion downstream from the second feed roller 3 in the sheet conveyance direction. The third sensor 43 is disposed at the position between the second conveyance roller pair 5 and the winding roller 20 and near a portion downstream from the second conveyance roller pair 5 in the sheet conveyance direction. The fourth sensor 44 serving as a sheet detection sensor is disposed at the position near a portion downstream from the winding roller 20 and upstream from the third conveyance roller pair 6 in the sheet conveyance direction. The fifth sensor 45 is disposed at the position downstream from the third conveyance roller pair 6 in the sheet conveyance direction.

A description is given of the winding roller 20 with reference to FIGS. 2A, 2B, 3A, 3B, 6B, 6B′, 6C, 6C′, 6D, and 7A.

FIG. 2A is a side view of a gripper 32 that has moved to a gripping position in the sheet separation device 1 illustrated in FIG. 1.

FIG. 2B is a side view of the gripper 32 that has moved to a releasing position in the sheet separation device 1 illustrated in FIG. 1.

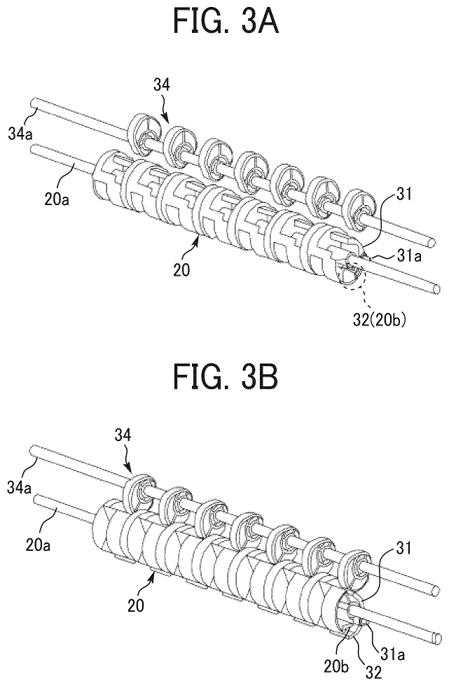

FIG. 3A is a perspective view of the gripper 32 that has moved to the gripping position in the sheet separation device 1 illustrated in FIG. 1

FIG. 3B is a perspective view of the gripper 32 that has moved to the releasing position in the sheet separator 1 illustrated in FIG. 1.

FIGS. 5A, 5B, 5C, and 5D are schematic views of the sheet separation device 1, each illustrating a sheet separating operation performed in the sheet separation device 1 illustrated in FIG. 1.

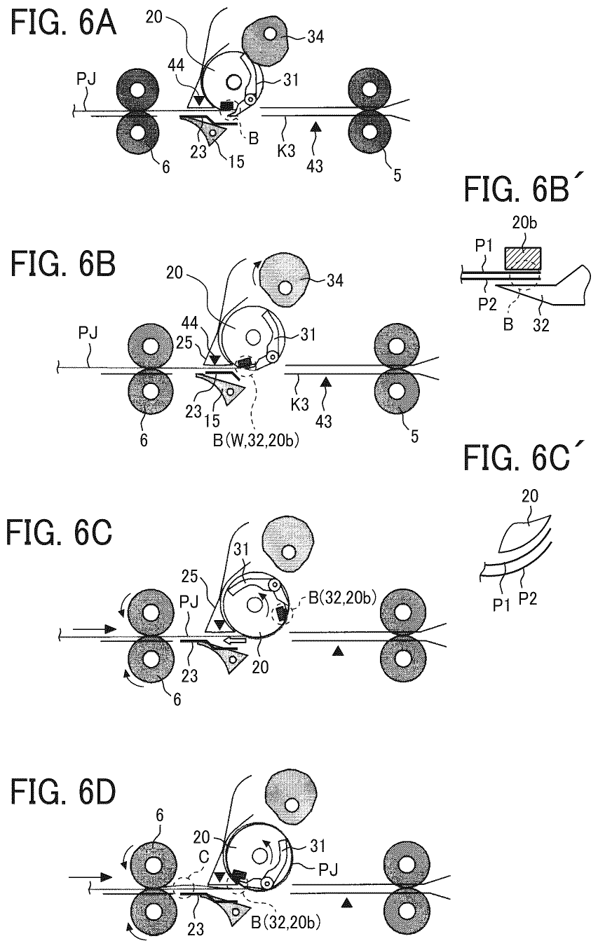

FIGS. 6A, 6B, 6B′, 6C, 6C′, and 6D are schematic views of the sheet separation device 1, each illustrating the sheet separating operation performed in the sheet separation device 1, subsequent from the sheet separating operation of FIGS. 5A, 5B, 5C, and 5D.

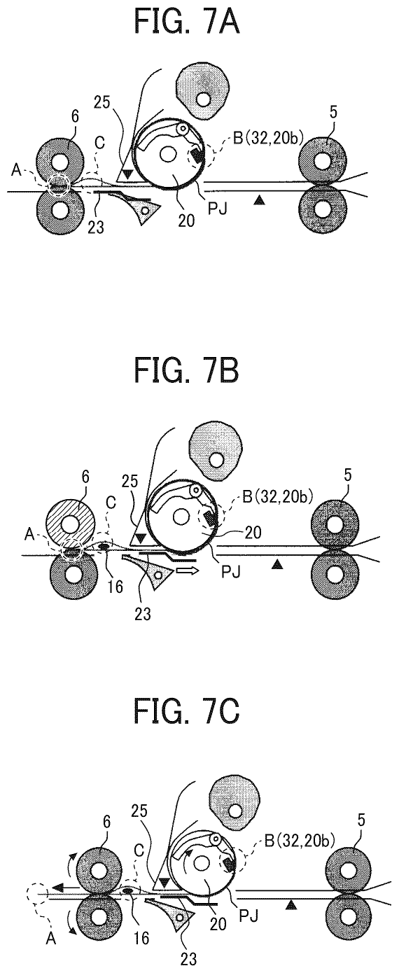

FIGS. 7A, 7B, and 7C are schematic views of the sheet separation device 1, each illustrating the sheet separating operation performed in the sheet separation device 1, subsequent from the sheet separating operation of FIGS. 6A, 6B, 6B′, 6C, 6C′, and 6D.

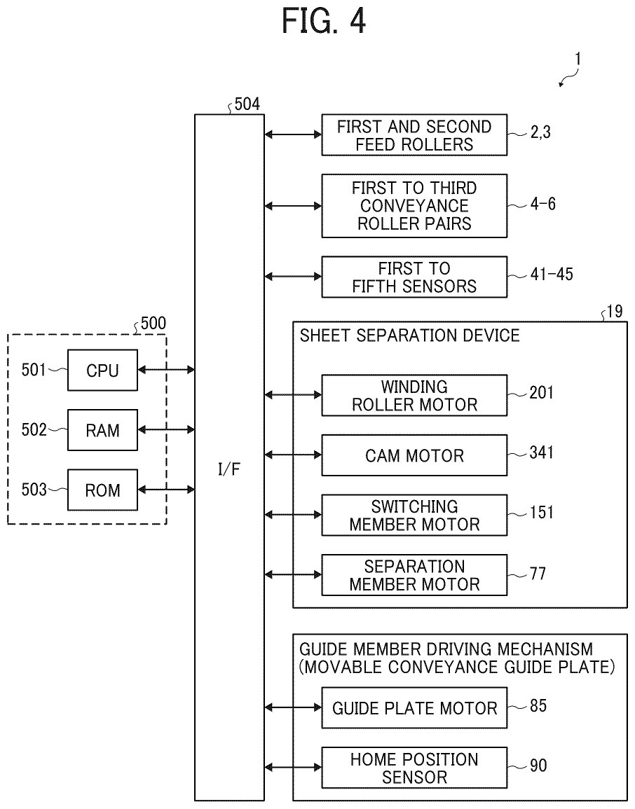

The winding roller 20 is a roller that rotates in a predetermined rotational direction to wind the two-ply sheet PJ around the winding roller 20 while the gripper 32 that functions as a handle gripping a gripped portion B of the two-ply sheet PJ at a winding start position W. The gripped portion B is an end of the two-ply sheet PJ that is the other end to the end at which the bonding portion A is formed, which is referred to as the other end of the two-ply sheet PJ. The winding roller 20 is rotatable around a rotary shaft 20a in the forward direction and in the reverse direction. The controller 500 controls a winding roller motor 201 (see FIG. 4) that drives the winding roller 20.

More specifically, as illustrated in FIG. 1, the two-ply sheet PJ starts from the first sheet tray 11 and passes through the first sheet conveyance passage K1, and the second conveyance roller pair 5 conveys the two-ply sheet PJ in the forward direction (normal direction) along the third sheet conveyance passage K3. The two-ply sheet PJ temporarily passes through the position of the winding roller 20, and then is conveyed to the position of the third conveyance roller pair 6. Then, the third conveyance roller pair 6 as a conveyance roller pair rotates in the reverse direction to convey the two-ply sheet PJ in the reverse direction to the position of the winding roller 20, and the gripper 32 grips the other end (leading end) of the two-ply sheet PJ. The two-ply sheet PJ is further conveyed while the other end (leading end) of the two-ply sheet PJ is gripped by the gripper 32, and the winding roller 20 rotates in the counterclockwise direction in FIG. 1 to wind the two-ply sheet PJ around the winding roller 20.

With reference to FIG. 6C′, as the winding roller 20 winds the two-ply sheet PJ, the linear velocity of the sheet P1 is proportional to the distance to the sheet P1 from the center of the winding roller 20 and the linear velocity of the sheet P2 is proportional to the distance to the sheet P2 from the center of the winding roller 20, so that the linear velocity of the surface of the winding roller 20 is proportional to the radius of the winding roller 20. Due to such a configuration, the sheet P1 is closer to the center of the winding roller 20 than the sheet P2, in other words, the sheet P1 is positioned at an inner side to the center of the winding roller 20 than the sheet P2, so that the linear velocity of the sheet P1 is lower than the linear velocity of the sheet P2.

As a result, the sheet P1 that is conveyed before the sheet P2 is more likely to slacken than the sheet P2. As illustrated in FIGS. 6D and 7A, a gap C is formed between the first sheet P1 and the second sheet P2 at the bonding portion A (the other end) of the two-ply sheet PJ, in other words, the gap C is formed as the first sheet P1 located upper than the second sheet P2 warps upward.

As described above, the first sheet P1 and the second sheet P2 that are in close contact with each other without any gap are separated (peeled) from each other.

A description is further given of a mechanism that generates the gap C in the two-ply sheet PJ between the winding roller 20 and the third conveyance roller pair 6 by winding the two-ply sheet PJ around the winding roller 20.

The two-ply sheet PJ wound around the winding roller 20 is gripped by the gripper 32, restricting displacement in the two-ply sheet PJ. Due to this configuration, a slip is generated between the first sheet P1 and the second sheet P2 by the amount of difference in the circumferential length of the winding roller 20. Due to the slip, the conveyance amount of the inner sheet (i.e., the first sheet P1) is smaller than the conveyance amount of the outer sheet (i.e., the second sheet P2). As a result, slack is generated in the inner sheet (i.e., the first sheet P1) between the nip region of the third conveyance roller pair 6 and the winding roller 20.

At this time, as the two-ply sheet PJ is wound around the winding roller 20 by one or more rounds, the difference in the winding circumferential length is generated between the inner circumference and the outer circumference by the thickness of the sheet. As a result, the slack is additionally generated.

Finally, the slack is collected between the third conveyance roller pair 6 and the winding roller 20, and the gap C is formed between the two sheets P1 and P2.

Specifically, a distance from the rotary shaft 20a (i.e., the center of the shaft) of the winding roller 20 to the outer sheet P2 is R+ΔR when a distance from the rotary shaft 20a (i.e. the center of the shaft) of the winding roller 20 to the inner sheet P1 is R, and the thickness of the inner sheet P1 is ΔR. Since the radius of the first sheet P1 wound around the inner side of the winding roller 20 and the radius of the second sheet P2 wound around the outer side of the first sheet P1 are different by the thickness ΔR of the first sheet P1 (wound around the inner side of the winding roller 20), a circumferential length difference of 2×ΔR×π is generated between the inner sheet (i.e., the first sheet P1) and the outer sheet (i.e., the second sheet P2) when the two-ply sheet PJ is wound around the winding roller 20 by one round. As a result, where the number of winding the two-ply sheet PJ around the winding roller 20 is M times, the slack of the inner sheet (i.e., the first sheet P1) is generated by the circumferential length difference of 2×ΔR×π×M.

Finally, the slack is accumulated between the third conveyance roller pair 6 and the winding roller 20, and the gap C corresponding to the circumferential length difference of 2×ΔR×π×M is formed between the first sheet P1 and the second sheet P2.

Particularly in the present embodiment, in order to significantly form the gap C as described above, the two-ply sheet PJ is wound around the winding roller 20 at least one round.

As described above, in the present embodiment, by providing the winding roller 20 to wind the two-ply sheet PJ around the rotary shaft 20a, the two-ply sheet PJ can be separated without increasing the size and cost of the sheet separation device 1.

As illustrated in FIG. 6B′, the gripper 32 illustrated in FIG. 2A in the present embodiment grips the gripped portion B of the two-ply sheet PJ without contacting the leading end face of the one end of the two-ply sheet PJ (the one end proximate to the gripped portion B).

In the present disclosure, the “end face” of the two-ply sheet is defined as a side face extending in the thickness direction and connecting the front face and the back face of the two-ply sheet. Accordingly, there are four end faces of the rectangular two-ply sheet on the front, back, left, and right.

More specifically, the gripper 32 nips and grips the gripped portion B of the two-ply sheet PJ in a direction orthogonal to the sheet surface of the gripped portion B of the two-ply sheet PJ between the gripper 32 and a receiving portion 20b of the winding roller 20 without restricting the end face of the one end of the two-ply sheet PJ from hitting any member, in other words, without causing any member to contact the end face of the two-ply sheet PJ. The receiving portion 20b of the winding roller 20 is a part of the outer circumferential portion of the winding roller 20 and can be arranged to face the gripper 32. More specifically, the receiving portion 20b is in a portion recessed inward from a virtual outer circumferential face of the winding roller 20. The virtual outer circumferential face is an outer circumferential face having a circular shape around which the two-ply sheet PJ is wound.

More specifically, the two-ply sheet PJ is not nipped and gripped by the gripper 32 and the receiving portion 20b of the winding roller 20 by being restricted while a specified member such as the gripper 32 contacts the end face of the one end (that is the leading end face). The two-ply sheet PJ is nipped and gripped by the gripper 32 and the receiving portion 20b while the end face of the one end (leading end face) does not contact any member.

Accordingly, the gripped portion B of the one end (leading end face) of the two-ply sheet PJ is gripped by the gripper 32 and the receiving portion 20b of the winding roller 20, and the end face (leading end face) of the one end of the two-ply sheet PJ does not contact an obtuse angle portion (wedge portion) of the gripper 32 in FIG. 6B′.

Without contacting any member, the end face (leading end) of the one end of the two-ply sheet PJ coincides with an end of a contact face of the receiving portion 20b at which the gripper 32 contacts the receiving portion 20b via the two-ply sheet PJ (the right end of the contact face in FIG. 6B′).

The end face (leading end) of the one end of the two-ply sheet PJ may move to the right end of the contact face in FIG. 6B′ avoiding the contact face between the gripper 32 and the receiving portion 20b so that the gripped portion B is inside the sheet from the leading end of the one end (the gripped portion B is in the portion proximate to the other end from the leading end of the one end) of the two-ply sheet PJ. Alternatively, the end face (leading end face) of the one end of the two-ply sheet PJ may be within the contact face between the gripper 32 and the receiving portion 20b of the winding roller 20 in FIG. 6B′.

Accordingly, when compared with a configuration in which the leading end face of the two-ply sheet PJ contacts a member, the above-described structure according to the present embodiment can reduce damage on the two-ply sheet PJ (particularly, the leading end).

In the present embodiment, the two-ply sheet PJ wound around the winding roller 20 has the bonding portion A at the one end of the two-ply sheet PJ and the gripped portion B at the other end of the two-ply sheet PJ.

In the present embodiment, at least the gripper 32 (handle) or the receiving portion 20b is made of elastic material such as rubber, spring, or leaf spring.

Compared with a sheet separation device including the gripper 32 and the receiving portion 20b that are rigid bodies made of metal or resin, the above-described sheet separation device can increase a gripping force to grip the two-ply sheet PJ and prevent surfaces of the two-ply sheet PJ from being damaged. In particular, when the gripper 32 and the receiving portion 20b included in the sheet separation device 1 are made of the elastic material, the sheet separation device 1 can easily achieve the above-described effect.

As illustrated in FIGS. 2A, 2B, 3A, and 3B, the movement mechanism 30 moves the gripper 32 at the winding start position W of the winding roller 20 between a gripping position (position illustrated in FIGS. 2A and 3A) at which the gripper 32 can grip the two-ply sheet PJ and a releasing position (position illustrated in FIGS. 2B and 3B) at which the gripper 32 is released from the gripping position.

More specifically, the movement mechanism 30 includes an arm 31, a compression spring 33, a cam 34, and a cam motor 341 (see FIG. 4). The compression spring 33 functions as a biasing member. The cam motor 341 drives to rotate the cam 34 in the forward direction or the reverse direction.

The arm 31 holds the gripper 32 and is held by the winding roller 20 to be rotatable about a support shaft 31a. In the present embodiment, the gripper 32 is coupled to the base of the arm 31, in other words, the leading end of the arm 31, and the gripper 32 and the arm 31 are integrally made (held) as a single unit. Alternatively, the gripper 32 and the arm 31 may be made as separate members, and the gripper 32 may be disposed on the arm 31, that is, may be held by the arm 31. In any case, the arm 31 holding the gripper 32 rotates around the rotary shaft 20a together with the winding roller 20 with the gripper 32.

The compression spring 33 functions as a biasing member that biases the arm 31 so that the gripper 32 moves from the releasing position illustrated in FIG. 2B to the gripping position illustrated in FIG. 2A. More specifically, one end of the compression spring 33 is coupled to a fixed position near the rotary shaft 20a, and the other end of the compression spring 33 is coupled to one end of the arm 31 that is a free end that is in the opposite direction to the other end of the arm 31 coupled to the gripper 32 interposed by the support shaft 31a.

The cam 34 pushes the arm 31 against the biasing force of the compression spring 33 that functions as the biasing member, so that the gripper 32 moves from the gripping position illustrated in FIG. 2A to the releasing position illustrated in FIG. 2B. The cam motor 341 that is controlled by the controller 500 drives the cam 34 to rotate in the forward direction or the reverse direction at a desired rotation angle. The cam 34 is held by the housing of the sheet laminator 50 so as to be rotatable around a cam shaft 34a separately from the winding roller 20.

In the movement mechanism 30 including the above-described configuration, as illustrated in FIGS. 2A and 3A, when the cam 34 is not in contact with the arm 31, the arm 31 is biased by the compression spring 33 to press the gripper 32 against the receiving portion 20b. This state is referred to as a closed state.

In contrast, as illustrated in FIGS. 2B and 3B, the arm 31 pressed by the cam 34 rotates counterclockwise in FIG. 2B about the support shaft 31a against the urging force of the compression spring 33 and separates the gripper 32 from the receiving portion 20b. This state is referred to as an open state. In the open state, the two-ply sheet PJ is not gripped, which is referred to as a grip release state.

When the gripper 32 is at the releasing position to be in the open state, the two-ply sheet PJ enters a space between the gripper 32 and the receiving portion 20b, and the gripper 32 moves to the gripping position to be in the closed state. As a result, the gripper 32 and the receiving portion 20b grip the two-ply sheet PJ.

In the present embodiment, as illustrated in FIGS. 3A and 3B, the winding roller 20 includes a plurality of roller portions (i.e., seven roller portions in the present embodiment) having a columnar shape and being disposed at given intervals in the axial direction of the winding roller 20. A plurality of grippers 32 and a plurality of arms 31 are disposed at divided positions between adjacent rollers, respectively. The divided positions are recesses between adjacent rollers. A plurality of cams 34 are disposed to be contactable to the plurality of arms 31, respectively.

The two-ply sheet PJ is not gripped at the position over the entire area of the winding roller 20 but is gripped at the divided positions at given intervals in the axial direction of the winding roller 20. By so doing, the load to grip the two-ply sheet PJ can be shared and scratch resistant at the leading end of the two-ply sheet PJ can be reduced. The above-described configuration is useful when a gripping force to grip the two-play sheet PJ increases, for example, when a large or heavy two-ply sheet PJ is gripped.

In the present embodiment, as illustrated in FIG. 1, the third sheet conveyance passage K3 is made of linear conveyance guide plates. By contrast, the third sheet conveyance passage K3 may be made of curved conveyance guide plates. In such a case, a gripping position at which the winding roller 20 grips the two-ply sheet PJ may be changed to be closer to the rotary shaft 20a than the gripping position in the present embodiment. Additionally, in such a case, the position of the gripper 32 according to the present embodiment and the position of the receiving portion 20b according to the present embodiment may be interchanged, so that the gripper 32 may be disposed closer to the rotary shaft 20a than the receiving portion 20b in the winding roller 20.

A description is given of the control system of the sheet separation device 1, with reference to FIG. 4.

FIG. 4 is a block diagram illustrating a hardware configuration of the control block of the sheet separation device 1 of FIG. 2 to control the operation of the sheet separation device 1.

As illustrated in FIG. 4, the sheet separation device 1 has the control system including a central processing unit (CPU) 501, a random access memory (RAM) 502, a read-only memory (ROM) 503, and an interface (I/F) 504. The CPU 501, the RAM 502, and the ROM 503 are connected via the I/F 504.

The CPU 501 is an arithmetic unit and controls the overall operation of the sheet separation device 1.

The RAM 502 is a volatile storage medium that allows data to be read and written at high speed. The CPU 501 uses the RAM 502 as a work area for data processing.

The ROM 503 is a read-only non-volatile storage medium that stores programs such as firmware.

The sheet separation device 1 processes, by an arithmetic function of the CPU 501, e.g., a control program stored in the ROM 503 and an information processing program (or application program) loaded into the RAM 502. Such processing configures a software controller including various functional modules of the sheet separation device 1. The software controller thus configured cooperates with hardware resources of the sheet separation device 1 construct functional blocks to implement functions of the sheet separation device 1. In other words, the CPU 501, the RAM 502, and the ROM 503 constitute the controller 500 to control the operation of the sheet separation device 1.

The I/F 504 is an interface that connects, for example, the first feed roller 2, the second feed roller 3, the first conveyance roller pair 4, the second conveyance roller pair 5, the third conveyance roller pair 6, the first sensor 41, the second sensor 42, the third sensor 43, the fourth sensor 44, the fifth sensor 45, the winding roller motor 201, the cam motor 341, a switching member motor 151, a separation member motor 77, a guide plate motor 85 (see FIG. 15), and a home position sensor 90 (see FIG. 15), to the controller 500. The controller 500 causes respective drive units to drive, for example, the first feed roller 2, the second feed roller 3, the first conveyance roller pair 4, the second conveyance roller pair 5, the third conveyance roller pair 6, the winding roller motor 201, the cam motor 341, the switching member motor 151, the separation member motor 77, and the guide plate motor 85, via the I/F 504. The controller 500 acquires detection results from, for example, the first sensor 41, the second sensor 42, the third sensor 43, the fourth sensor 44, the fifth sensor 45 and the home position sensor 90.

The winding roller motor 201 is a drive unit to drive the winding roller 20.

The cam motor 341 is a drive unit to drive the cam 34. The switching member motor 151 is a drive unit to drive the switching members 15. The guide plate motor 85 is a drive unit to slidably move (slide) the movable conveyance guide plate 23.

A description is given of the fourth sensor 44 provided for the sheet separation device 1 according to the present embodiment, with reference to FIGS. 1, 5D, and 6A.

The fourth sensor 44 functions as a sheet detection sensor to detect the two-ply sheet PJ that is conveyed toward the winding roller 20. Based on the detection results of the fourth sensor 44 serving as a sheet detection sensor, the controller 500 controls the movement mechanism 30.

More specifically, the fourth sensor 44 is disposed on the conveyance guide in the sheet conveyance passage between the winding roller 20 and the third conveyance roller pair 6. As illustrated in FIGS. 5D and 6A, when the third conveyance roller pair 6 conveys the two-ply sheet PJ in the reverse direction toward the position of the winding roller 20 in the reverse direction, with the gripped portion B of the two-ply sheet PJ being the leading end, the fourth sensor 44 detects the leading end (i.e., the end of the gripped portion B) of the two-ply sheet PJ. In response to the detection timing at which the fourth sensor 44 detects the leading end (in the reverse direction) of the gripped portion B, the controller 500 adjusts and controls the timing to stop the two-ply sheet PJ at the gripping position and the timing at which the gripper 32 grips the gripped portion B. More specifically, after a given time has elapsed from the detection of the leading end of the two-ply sheet PJ by the fourth sensor 44, the third conveyance roller pair 6 stops conveyance of the two-ply sheet PJ in the reverse direction, and the cam 34 rotates to pivot the arm 31 of the movement mechanism 30 so that the gripper 32 moves from the releasing position illustrated in FIG. 2B to the gripping position illustrated in FIG. 2A.

The above-described control accurately performs an operation in which the end face of the two-ply sheet PJ is nipped by the gripper 32 and the receiving portion 20b without contacting the end face of the two-ply sheet PJ on any member.

As described above, the third conveyance roller pair 6 is a conveyance roller pair that conveys the two-ply sheet PJ with the one end (i.e., the gripped portion B) as a leading end, toward the winding start position W of the winding roller 20 in the sheet conveyance passage (a part of the third sheet conveyance passage K3) between the third conveyance roller pair 6 and the winding roller 20.

A description is given of the separation members 16 as each as a separator, with reference to FIGS. 7A, 7B, 7C, 10, 11A, 11B, and 11C.

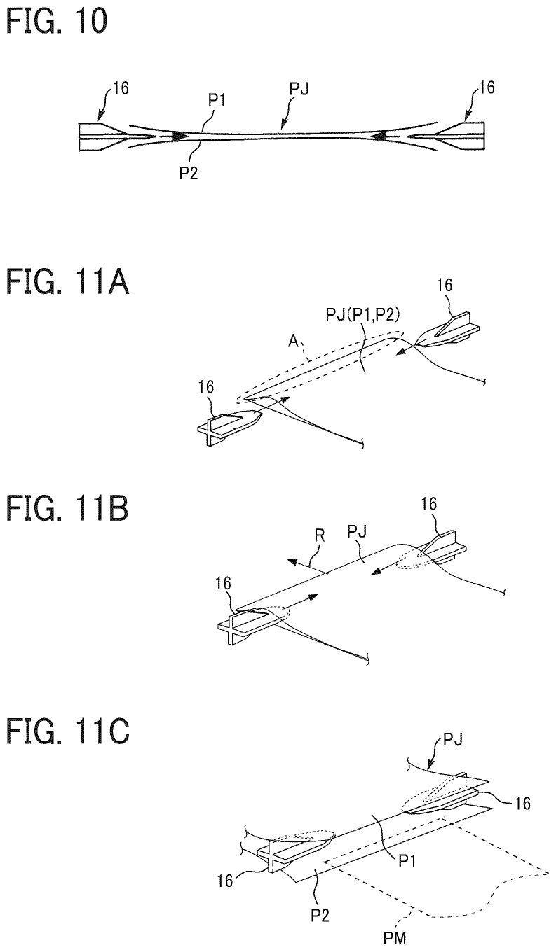

FIG. 10 is a schematic view of the separation members 16 inserted into the two-ply sheet PJ in the width direction of the two-ply sheet PJ.

FIGS. 11A, 11B, and 11C are perspective views of the separation members 16, each illustrating the operations of the separation members 16 in the width direction of the two-ply sheet PJ.

The separation members 16 each as a separator move from a retracted position to be inserted into the gap C formed between the first sheet P1 and the second sheet P2 at a position between the winding roller 20 and the third conveyance roller pair 6 from the outside of both ends of the two-ply sheet PJ in the width direction of the two-ply sheet PJ, with respect to the two-ply sheet PJ when the one end (that is the gripped portion B) is wound by the winding roller 20 and the other end (that is the bonding portion A) is nipped by the third conveyance roller pair 6 (sheet conveyance roller pair). The retracted position is a position where the separation members 16 do not hinder a conveyance of the two-ply sheet PJ (or the inner sheet PM), in other words, a position that allows a smooth conveyance of the two-two-ply sheet PJ or the inner sheet PM.

More specifically, in the present embodiment, the separation members 16 are disposed at both ends of the two-ply sheet PJ in the width direction that is the direction perpendicular to a plane on which FIGS. 7A, 7B, and 7C are illustrated and the horizontal direction in FIG. 10. The separation members 16 are separation plates, more specifically, the separation members 16 have respective fins extending in the vertical direction from respective plates. In the direction in which the separation members 16 are inserted into the two-ply sheet PJ, each of the respective plates has the rear end and the front end at the center in the width direction of the plates. The plate thickness and the plate width of each of the respective plates gradually increase from the front end to the rear end of the fin. The vertical length (length in the vertical direction) of the fin gradually increases from the front end of the fin in the direction in which the separation member 16 is inserted into the two-ply sheet PJ. The fin and the plate in each of the separation members 16 form a cross shape at the rear end of the fin (see FIG. 11A). Further, the separation members 16 are movable in the width direction of the two-ply sheet PJ by a moving device controlled by the controller 500 so as not to contact with each other.

The separation members 16 having the above-described configuration stand by at respective retracted position (see FIG. 11A) at which the separation members 16 do not interfere with conveyance of the sheet such as the two-ply sheet PJ in the third sheet conveyance passage K3 until the gap C is formed between the two sheets (the first sheet P1 and the second sheet P2) of the two-ply sheet PJ, as illustrated in FIG. 7A. Subsequently, as illustrated in FIGS. 10 and 11B, the separation members 16 enter the gap C in the two-ply sheet PJ when separating the two-ply sheet PJ (including the first sheet P1 and the second sheet P2). As a result, the separation members 16 give the gap C to be relatively large. The moving device that moves the separation members 16 in the width direction of the two-ply sheet PJ may employ, for example, a rack and pinion mechanism.

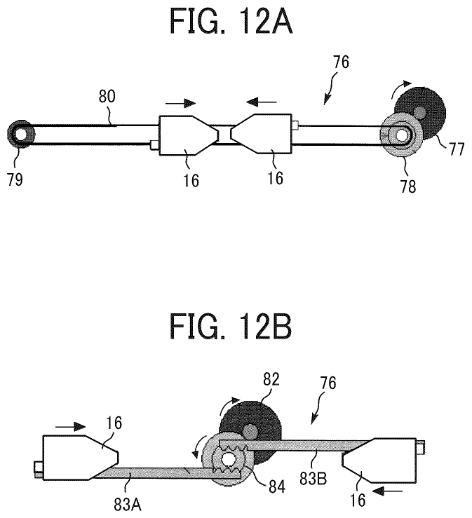

More specifically, the moving device that moves the pair of separation members 16 in the width direction may employ a driving mechanism 76 as illustrated in FIG. 12A or FIG. 12B.

FIGS. 12A and 12B are schematic view of the driving mechanism 76 to move the separation members 16.

In the present embodiment, the two separation members 16 are disposed facing each other, as illustrated in FIGS. 12A and 12B. The driving mechanism 76 illustrated in FIG. 12A moves the two separation members 16 by a belt driving. On the other hand, the driving mechanism 76 illustrated in FIG. 12B moves the two separation members 16 by a rack and pinion driving.

More specifically, the driving mechanism 76 illustrated in FIG. 12A includes a belt 80 stretched between a drive pulley 78 and a driven pulley 79 and the two separation members 16 are attached to the belt 80 while facing each other. Of the two separation members 16, one separation member 16 is attached and connected to the lower part of the belt 80 and the other separation member 16 is attached and connected to the upper part of the belt 80. The drive pulley 78 includes a drive gear that meshes with a motor gear mounted on the motor shaft of the separation member motor 77. The rotation output of the separation member motor 77 is transmitted to the belt 80. More specifically, as the motor gear of the separation member motor 77 rotates in the clockwise direction in FIG. 12A, the two separation members 16 approach toward each other. On the other hand, as the motor gear of the separation member motor 77 rotates in the counterclockwise direction in FIG. 12A, the two separation members 16 move away from each other.

The driving mechanism 76 illustrated in FIG. 12B includes two racks 83A and 83B extending in opposite directions from each other. Each of the racks 83A and 83B meshes with a single pinion 84. One separation member 16 that is attached to the rack 83A faces the other separation member 16 that is attached to the rack 83B. The pinion 84 includes a drive gear that meshes with a motor gear mounted on the motor shaft of a drive motor 82. The rotational output of the drive motor 82 is transmitted to the racks 83A and 83B. More specifically, as the motor gear of the drive motor 82 rotates in the clockwise direction in FIG. 12B, the two separation members 16 approach toward each other. On the other hand, as the motor gear of the separation member motor 77 rotates in the counterclockwise direction in FIG. 12B, the two separation members 16 move away from each other.

As described above, each of the separation members 16 of the present embodiment has the above-described shape having the plate and the fin extending in the vertical direction and is movable in the width direction of the two-ply sheet PJ due to the driving by the driving mechanism 76. Due to such a configuration, the separation members 16 are smoothly inserted into the gap C generated in the two-ply sheet PJ as illustrated in FIG. 11B.

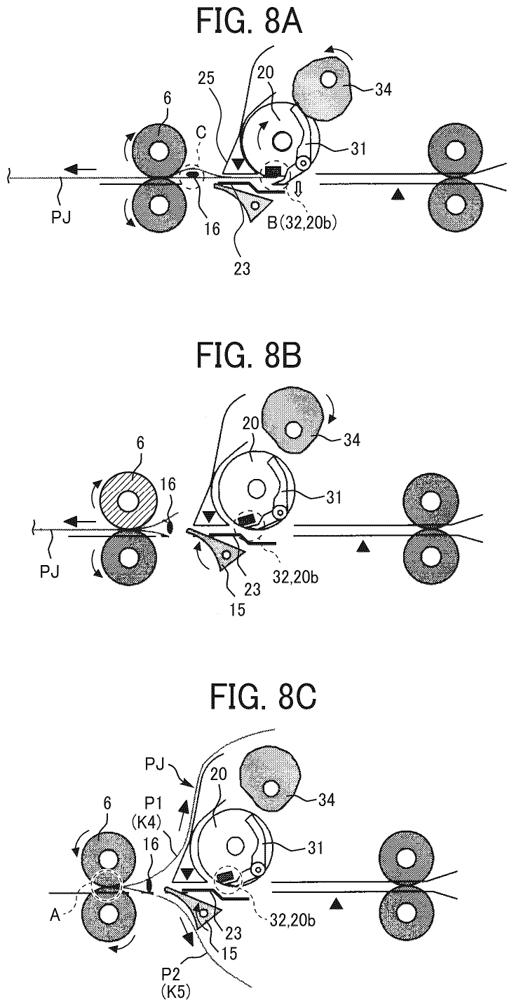

A description is given of the switching members 15, with reference to FIGS. 8A, 8B, and 8C.

FIGS. 8A, 8B, and 8C are schematic views of the sheet separation device 1, each illustrating the sheet separating operation performed in the sheet separation device 1, subsequent from the sheet separating operation of FIGS. 7A, 7B, and 7C.

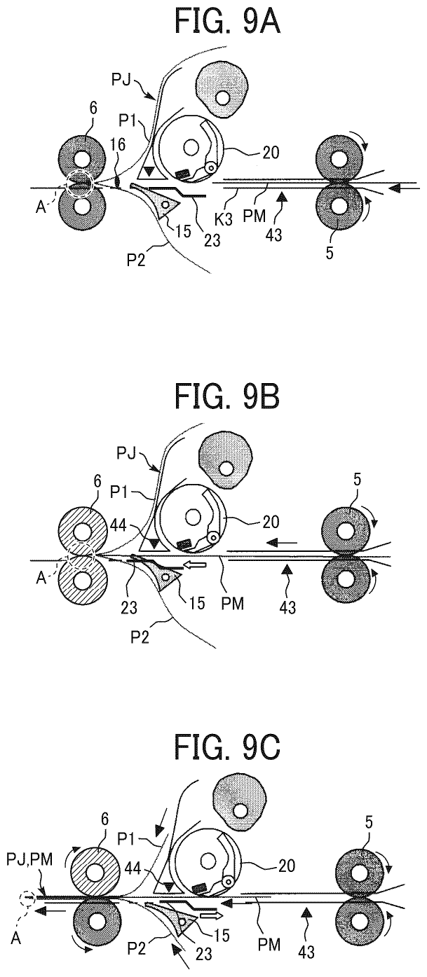

FIGS. 9A, 9B, and 9C are schematic views of the sheet separation device 1, each illustrating the sheet separating operation performed in the sheet separation device 1, subsequent from the sheet separating operation of FIGS. 8A, 8B, and 8C.

As illustrated in FIGS. 8A, 8B, and 8C, the switching members 15 are switching plates disposed between the separation members 16 and the winding roller 20. Note that the switching members 15 may also be referred to in a singular form as “switching member 15” for convenience. The two-ply sheet PJ is separated into the two sheets, which are the first sheet P1 and the second sheet P2, by the separation members 16, and the two sheets P1 and P2 of the two-ply sheet PJ having stiffness are guided to respective directions different from each other, specifically, to the first branched sheet conveyance passage K4 and the second branched sheet conveyance passage K5, respectively. The first branched sheet conveyance passage K4 and the second branched sheet conveyance passage K5 are branched from the sheet conveyance passage between the winding roller 20 and the third conveyance roller pair 6 (a part of the third sheet conveyance passage K3), across the third sheet conveyance passage K3. The switching member 15 is a claw-shaped moving member to rotate in forward or in reverse within a range of a predetermined angle to guide the two-ply sheet PJ.

More specifically, in the present embodiment, the switching members 15 are spaced apart from each other in the width direction of the two-ply sheet PJ, in other words, in the direction perpendicular to a plane of the drawing sheets on which FIGS. 8A, 8B, and 8C are illustrated, so as not to interfere, for example, the movable conveyance guide plate 23. Further, the switching members 15 are rotatable around the support shaft by the switching member motor 151 (see FIG. 4) that is controlled by the controller 500.

The switching members 15 having the above-described configuration stand by at respective standby positions (see FIG. 8A) at which the switching members 15 do not interfere with conveyance of the sheet such as the two-ply sheet PJ in the third sheet conveyance passage K3 until the first sheet P1 and the second sheet P2 of the two-ply sheet PJ separated by the separation members 16 are guided to the first branched sheet conveyance passage K4 and the second branched sheet conveyance passage K5, respectively. When the switching members 15 guide the two sheets P1 and P2 separated from the two-ply sheet PJ by the separation members 16 to the first branched sheet conveyance passage K4 and the second branched sheet conveyance passage K5, respectively, in other words, in the directions different from each other, the switching members 15 rotate to the positions at which the switching members 15 prevent the two-ply sheet PJ from entering the third sheet conveyance passage K3 when viewed from the two-ply sheet PJ as illustrated in FIG. 8B.

As a result, the first sheet P1 is guided to the first branched sheet conveyance passage K4, and the second sheet P2 is guided to the second branched sheet conveyance passage K5.

More specifically, as illustrated in FIG. 8A, after the separation members 16 are inserted into the gap C, the third conveyance roller pair 6 conveys the two-ply sheet PJ to the other end (left side) so that the winding of the one end of the two-ply sheet PJ on the winding roller 20 is released. In other words, the controller 500 causes the third conveyance roller pair 6 to convey the two-ply sheet PJ toward the other end of the two-ply sheet PJ (i.e., the left side in FIG. 8A). After the two-ply sheet PJ has been conveyed as illustrated in FIG. 8B, the third conveyance roller pair 6 conveys the two-ply sheet PJ to the one end (right side) again as illustrated in FIG. 8C. Then, the first sheet P1 that is one of the two sheets of the two-ply sheet PJ separated by the separation members 16 is guided to the first branched sheet conveyance passage K4, and the second sheet P2 that is the other of the two sheets of the two-ply sheet PJ is guided to the second branched sheet conveyance passage K5. Subsequently, as illustrated in FIGS. 9A, 9B, and 9C, the second conveyance roller pair 5 conveys the inner sheet PM to the other end of the third sheet conveyance passage K3 to insert the inner sheet PM between the first sheet P1 and the second sheet P2 separated from the two-ply sheet PJ.

Referring to FIG. 7A, the first guide 25 is included in the sheet separation device 1 according to the present embodiment. The first guide 25 is disposed between the separation members 16 (see FIG. 7B) and the winding roller 20 in the third sheet conveyance passage K3. The first guide 25 functions as an inner restrictor to limit an amount of slack of the first sheet P1 that is wound around the winding roller 20 on the inner side, among the first sheet P1 and the second sheet P2 of the two-ply sheet PJ wound around the winding roller 20.

The movable conveyance guide plate 23 as a movable conveyance guide can guide the two-ply sheet PJ or the inner sheet PM. As illustrated in, for example, FIGS. 5B and 5C, the movable conveyance guide plate 23 is movable in the forward and reverse directions (the left-and-right direction as indicated by the white arrows in FIGS. 5B and 5C) in the conveyance passage between the winding roller 20 and the third conveyance roller pair 6 as a conveyance roller pair (a part of the third sheet conveyance passage K3).

More specifically, the movable conveyance guide plate 23 (movable conveyance guide) is disposed opposite to the position of the winding roller 20 in the third sheet conveyance passage K3. To be more specific, the movable conveyance guide plate 23 is disposed below the third sheet conveyance passage K3 as illustrated in, for example, FIGS. 5A, 5B, 5C, and 5D.

The movable conveyance guide plate 23 is movable between a first position (the reference position) illustrated in FIGS. 5A and 5D and a second position illustrated in FIGS. 5B and 5C.

The first position (reference position) is a position in a conveyance guide range from the winding roller 20 (including the nearby area) to an upstream position (a position upstream in the forward direction) from the separation members 16 (separators) in the third sheet conveyance passage K3. In other words, the first position is a position in a range of the conveyance guide face 23a to actually guide a sheet in the conveyance direction of a sheet, as illustrated in FIG. 15. On the other hand, the second position is a position in a conveyance guide range from the upstream position in the forward direction from the separation members 16 to the third conveyance roller pair 6 (including the nearby area) in the third sheet conveyance passage K3.

The movable conveyance guide plate 23 having this configuration moves from the first position to the second position (or the second position to the first position) in accordance with a movement of the two-ply sheet PJ to be conveyed in the forward direction or the reverse direction (or the inner sheet PM to be conveyed in the forward direction) in the conveyance passage between the winding roller 20 and the third conveyance roller pair 6.

Due to such a configuration with the movable conveyance guide plate 23, the conveyance failure of the two-ply sheet PJ or the inner sheet PM is less likely to occur in the conveyance passage between the winding roller 20 and the third conveyance roller pair 6.

Since the separation member 16 (separation member) is appropriately moved from the retracted position to the widthwise center side and the first branched sheet conveyance passage K4 and the second branched sheet conveyance passage K5 are disposed in the conveyance passage between the winding roller 20 and the third conveyance roller pair 6, if a conveyance guide plate is fixedly installed in the entire area of the conveyance passage between the winding roller 20 and the third conveyance roller pair 6, the separation members 16 interfere with the conveyance guide plate or the sheet cannot be conveyed to the first branched sheet conveyance passage K4 and the second branched sheet conveyance passage K5. In contrast, if the conveyance guide plate is not installed in order to prevent such an inconvenience, a conveyance failure is likely to occur. For example, the conveyance direction of the two-ply sheet PJ or the inner sheet PM is not determined and the two-ply sheet PJ or the inner sheet PM is jammed without being fed into the nip region of the rollers of the third conveyance roller pair 6.

Once such a conveyance failure occurs, the two sheets of the two-ply sheet PJ cannot be preferably separated, or the inner sheet PM cannot be preferably inserted into the two sheets of the two-ply sheet PJ.

In contrast, in the present embodiment, the movable conveyance guide plate 23 movable in the forward and reverse directions is disposed in the conveyance passage between the winding roller 20 and the third conveyance roller pair 6, and the movable conveyance guide plate 23 is moved between the first position and the second position in accordance with the movement of the two-ply sheet PJ and the inner sheet PM and the movement of the separation members 16. By so doing, the above-described inconvenience is less likely to occur.

Specifically, referring to FIGS. 5A and 5B, in the present embodiment, when the two-ply sheet PJ is conveyed in the forward direction with the separation members 16 (separation member) at the retracted position in the third sheet conveyance passage K3 (conveyance passage), the movable conveyance guide plate 23 is controlled to be moved from the first position to the second position in accordance with the conveyance of the two-ply sheet PJ.

More specifically, the movable conveyance guide plate 23 is at the first position (reference position) illustrated in FIG. 5A until the two-ply sheet PJ passes the vicinity of the winding roller 20. As the two-ply sheet PJ is further conveyed in the forward direction, the movable conveyance guide plate 23 is moved from the first position to the second position in accordance with the conveyance of the two-ply sheet PJ. The timing of moving the movable conveyance guide plate 23 is calculated based on, for example, the conveyance speed obtained by the detection of the leading end (the bonding portion A) of the two-ply sheet PJ by the third sensor 43. Accordingly, the two-ply sheet PJ can be smoothly guided to the third conveyance roller pair 6.

Further, referring to FIGS. 5C and 5D, when the two-ply sheet PJ is conveyed in the reverse direction with the separation members 16 (separation member) at the retracted position in the third sheet conveyance passage K3 (conveyance passage), the movable conveyance guide plate 23 is controlled to be moved from the second position to the first position in accordance with the conveyance of the two-ply sheet PJ.

More specifically, the movable conveyance guide plate 23 is at the second position illustrated in FIG. 5C when the third conveyance roller pair 6 starts to rotate in the reverse direction to wind the two-ply sheet PJ around the winding roller 20. As the two-ply sheet PJ is further conveyed in the reverse direction, the movable conveyance guide plate 23 is moved from the second position to the first position in accordance with the conveyance of the two-ply sheet PJ, as illustrated in FIG. 5D. The timing of moving the movable conveyance guide plate 23 is calculated based on, for example, the drive timing of the third conveyance roller pair 6 or the conveyance speed. Accordingly, the two-ply sheet PJ can be smoothly guided to the winding roller 20.

In the present embodiment, as illustrated in FIGS. 6C and 6D, when the two-ply sheet PJ is wound around the winding roller 20 to form a slack due to the circumferential length difference of the two sheets, which are the first sheet P1 and the second sheet P2, to form the gap C, the movable conveyance guide plate 23 is moved to the second position. By so doing, the lower face of the portion of the two-ply sheet PJ where the gap C is formed is supported by the movable conveyance guide plate 23, so that a preferable gap C (to which the separation members 16 are later inserted) can be formed.

Referring to, for example, FIGS. 7B, 7C, and 8, the movable conveyance guide plate 23 is controlled to be located at the first position (reference position) when the separation members 16 (separation member) are moved from the retracted position to be inserted into the gap C while the two-ply sheet PJ is being conveyed in the forward direction or the reverse direction in the third sheet conveyance passage K3 (the conveyance passage).

By controlling the movable conveyance guide plate 23 as described above, the separation members 16 do not interfere with the movable conveyance guide plate 23, and the function of the movable conveyance guide plate 23 is sufficiently exhibited.

Further, when the two-ply sheet PJ (having the first sheet P1 and the second sheet P2) is conveyed to the first branched sheet conveyance passage K4 and the second branched sheet conveyance passage K5, the movable conveyance guide plate 23 is at the first position (reference position). By controlling the movable conveyance guide plate 23 as described above, the two-ply sheet PJ (having the first sheet P1 and the second sheet P2) is also smoothly conveyed to the first branched sheet conveyance passage K4 and the second branched sheet conveyance passage K5.

Further, referring to FIGS. 9A and 9B, the movable conveyance guide plate 23 is controlled to move from the first position to the second position in accordance with the conveyance of the inner sheet PM in the forward direction when the inner sheet PM is inserted between the two sheets, which are the first sheet P1 and the second sheet P2, of the two-ply sheet PJ with the first sheet P1 and the second sheet P2 of the two-ply sheet PJ separated from each other at the first branched sheet conveyance passage K4 and the second branched sheet conveyance passage K5, respectively, in the third sheet conveyance passage K3 (conveyance passage).

More specifically, the movable conveyance guide plate 23 is at the first position (reference position) as illustrated in FIG. 9A after the sheet separating operation is performed on the two-ply sheet PJ and until the inner sheet PM passes the vicinity of the winding roller 20. As the inner sheet PM is further conveyed in the forward direction, the movable conveyance guide plate 23 is moved from the first position to the second position in accordance with the conveyance of the inner sheet PM. The timing of moving the movable conveyance guide plate 23 is calculated based on, for example, the conveyance speed obtained by the detection of the leading end of the inner sheet PM by the third sensor 43. Accordingly, the inner sheet PM can be smoothly guided to the third conveyance roller pair 6 (between the first sheet P1 and the second sheet P2).

Further, referring to FIG. 9C, the movable conveyance guide plate 23 is controlled to move from the second position to the first position (reference position) when the two-ply sheet PJ with the inner sheet PM inserted between the first sheet P1 and the second sheet P2 is conveyed in the forward direction by the third conveyance roller pair 6.

As the leading end of the inner sheet PM is inserted between the first sheet P1 and the second sheet P2 of the two-ply sheet PJ, the third conveyance roller pair 6 is rotated in the forward direction, and the inner sheet PM and the first sheet P1 and the second sheet P2 of the two-ply sheet PJ are conveyed in the forward direction. While doing the above-described operations, the insertion of the inner sheet PM between the first sheet P1 and the second sheet P2 of the two-ply sheet PJ is completed.

At this time, the movable conveyance guide plate 23 is retracted to the first position (reference position). By so doing, the two-ply sheet PJ and the movable conveyance guide plate 23 can avoid a sliding contact with each other. Accordingly, damage on the movable conveyance guide plate 23 due to the sliding contact of the two-ply sheet PJ is less likely to occur.

FIG. 15 is a perspective view of a movable conveyance guide plate and a guide member driving mechanism.

Referring to, for example, FIG. 15, the movable conveyance guide plate 23 is disposed to be movable in the horizontal direction between the first position and the second position by a guide member driving mechanism.

Specifically, in the present embodiment, the guide member driving mechanism includes the guide plate motor 85, pulleys 86A and 86B, a timing belt 87, and guide rods 88. The movable conveyance guide plate 23 is slidably held by the guide rods 88 at both widthwise ends of the movable conveyance guide plate 23. A retainer 23d that is fixedly retained to the timing belt 87 is attached to one widthwise end of the movable conveyance guide plate 23. On the other hand, a motor gear mounted on the motor shaft of the guide plate motor 85 is meshed with a gear portion in steps on the pulley 86A. The timing belt 87 is wound around the pulleys 86A and 86B. With the guide member driving mechanism having the above-described configuration, the controller 500 controls the driving of the guide plate motor 85 to rotate in the forward and reverse directions, so that the movable conveyance guide plate 23 slidably move between the first position (reference position) and the second position in the forward and reverse directions.

In the present embodiment, a home position sensor 90 is disposed with the guide member driving mechanism to optically detect the movable conveyance guide plate 23 at the first position (reference position). The guide plate motor 85 is a stepping motor, and can grasp the movable conveyance guide plate 23 at the second position, from the number of motor pulses of the movable conveyance guide plate 23 at the first position.

Referring to FIG. 15, in the present embodiment, the movable conveyance guide plate 23 has a conveyance guide face 23a (a face that actually guides a sheet) on the downstream side in the conveyance direction (specifically, the downstream side in the forward direction of the conveyance direction). The movable conveyance guide plate 23 also has a supplemental face 23b (horizontal plane) on the upstream side in the conveyance direction, in a direction (the lower part in, for example, FIGS. 5A, 5B, 5C, and 5D) away from the conveyance guide face 23a. The movable conveyance guide plate 23 also has a sloped face 23c to be coupled to the supplemental face 23b and the conveyance guide face 23a.

By disposing the movable conveyance guide plate 23 as described above, even if the leading end of the two-ply sheet PJ or the inner sheet PM conveyed in the forward direction is bent downward, the leading end of the two-ply sheet PJ or the inner sheet PM is guided to the conveyance guide face 23a along the supplemental face 23b or the sloped face 23c. Then, the two-ply sheet PJ or the inner sheet PM are smoothly conveyed in the forward direction with the movable conveyance guide plate 23.

A description is given of the operations performed in the sheet separation device 1 (sheet separation unit 19) to separate the two-ply sheet PJ, with reference to FIGS. 5A to 9C.

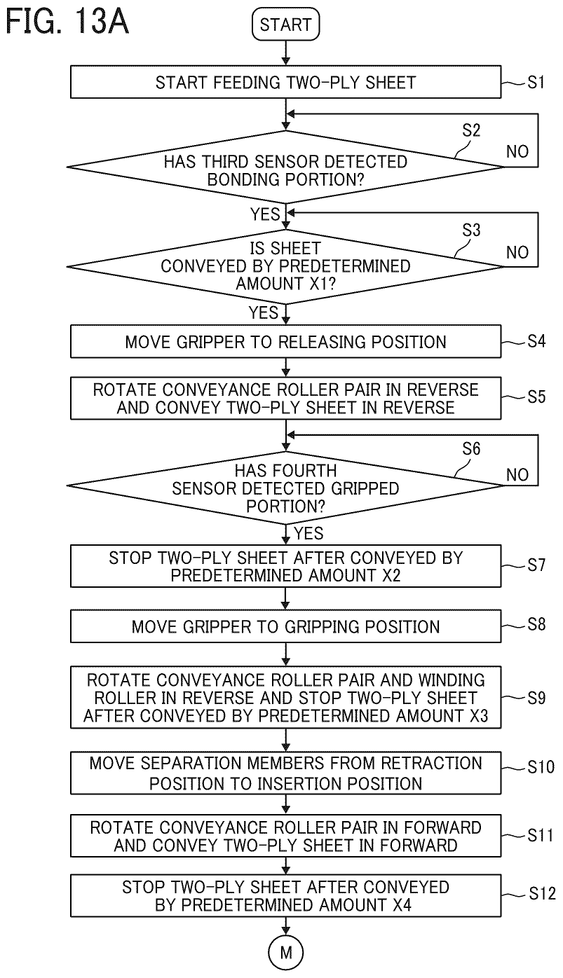

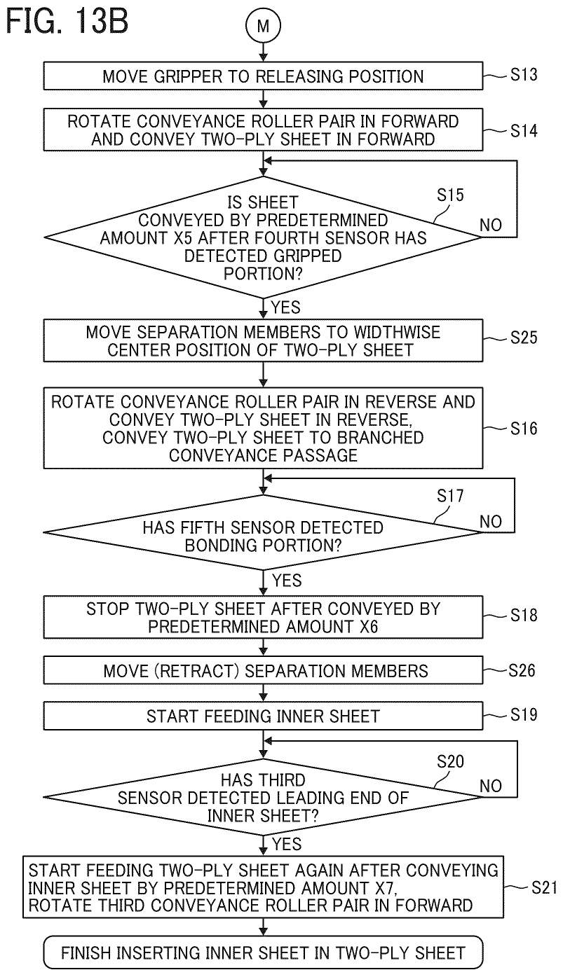

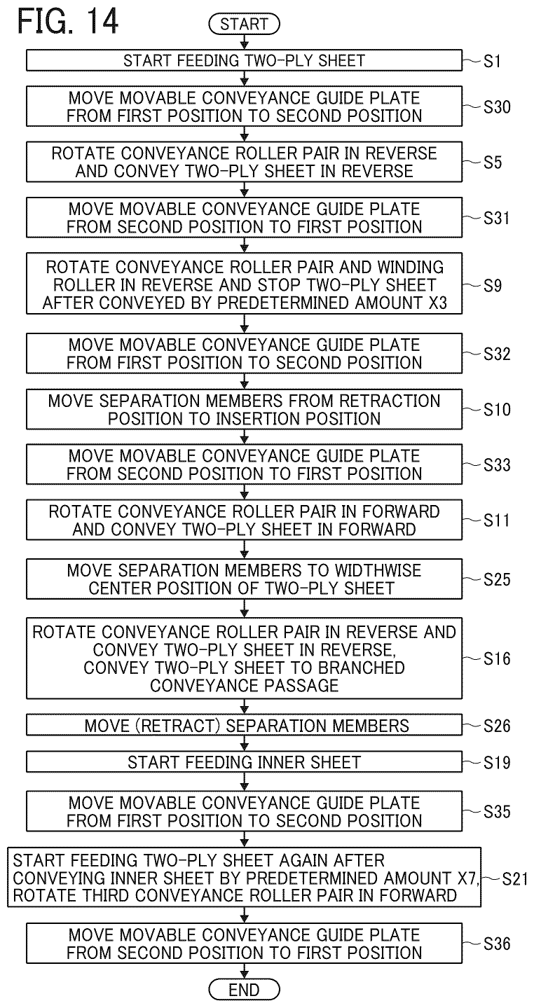

Further, in the description of the operations, the operations of the separation members 16 are appropriately described with reference to FIGS. 10 to 11C, and the control flow is described with reference to a flowchart of FIG. 13 including FIGS. 13A and 13B and FIG. 14.

FIG. 13 including FIGS. 13A and 13B is a flowchart of the control process executed in the sheet separation device 1.

FIG. 14 is a flowchart of the control process of a movable conveyance guide plate executed in the sheet separation device 1.

First, the first feed roller 2 and the first conveyance roller pair 5 start feeding the two-ply sheet PJ from the first sheet tray 11 (step S1 of the flowchart in FIG. 13A). Then, as illustrated in FIG. 5A, the second conveyance roller pair 5 conveys the two-ply sheet PJ with the bonding portion A as the leading end of the two-ply sheet PJ in the forward direction in the third sheet conveyance passage K3. The forward direction is a direction indicated by arrow R in FIGS. 5A and 5B.

At this time, the controller 500 causes the movement mechanism 30 to locate the gripper 32 at the gripping position that is inside of the outer circumference of the winding roller 20. In other words, the cam 34 rotates to move to a position at which the cam 34 does not press the arm 31. When the gripper 32 is located at the gripping position as described above, the gripper 32 does not interrupt conveyance of the sheet in the third sheet conveyance passage K3.

The switching members 15 rotate the free end downward and stand by at the standby positions at which the switching members 15 do not interrupt the conveyance of the sheet in the third sheet conveyance passage K3. The separation members 16 are retracted to the retracted position (the position illustrated in FIG. 11A), and the movable conveyance guide plate 23 is positioned at the first position (the position illustrated in FIG. 5A).

Then, as illustrated in FIG. 5B, the third conveyance roller pair 6 conveys the two-ply sheet PJ until the gripped portion B of the two-ply sheet PJ (i.e., the trailing end of the two-ply sheet PJ conveyed in the forward direction, in other words, the one end of the two-ply sheet PJ) passes through the position of the winding roller 20. As the two-ply sheet PJ is further conveyed in the forward direction, after the leading end (the bonding portion A) of the two-ply sheet PJ reaches the position of the conveyance guide face 23a of the movable conveyance guide plate 23, the movable conveyance guide plate 23 is moved from the first position to the second position (step S30 in the flowchart of FIG. 14).

Then, as illustrated in FIG. 5C, the controller 500 causes the third conveyance roller pair 6 to stop the conveyance of the two-ply sheet PJ. Specifically, the controller 500 determines whether the third sensor 43 detects the bonding portion A of the two-ply sheet PJ (i.e., the leading end of the two-ply sheet PJ conveyed in the forward direction, that is, the other end of the two-ply sheet PJ) in step S2 of the flowchart in FIG. 13A. When the third sensor 43 has not detected the bonding portion A of the two-ply sheet PJ (NO in step S2 of FIG. 13A), step S2 is repeated until the third sensor 43 detects the bonding portion A of the two-ply sheet PJ. In contrast, when the third sensor 43 has detected the bonding portion A of the two-ply sheet PJ (YES in step S2 of FIG. 13A), in response to the timing of detection of the bonding portion A of the two-ply sheet PJ by the third sensor 43, the controller 500 causes the third conveyance roller pair 6 to convey the two-ply sheet PJ in the forward direction by a predetermined amount X1, in step S3 of the flowchart in FIG. 13A, and stops the conveyance of the two-ply sheet PJ.

Then, as illustrated in FIG. 5C, in response to the temporary stop of the conveyance of the two-ply sheet PJ by the third conveyance roller pair 6, the controller 500 causes the gripper 32 to move from the gripping position to the releasing position, in step S4 of the flowchart in FIG. 13A. In other words, the controller 500 causes the cam 34 to rotate to the position at which the cam 34 presses the arm 31. While the cam 34 presses the arm 31, the gripped portion B of the two-ply sheet PJ can be received between the gripper 32 and the receiving portion 20b of the winding roller 20.

Then, as illustrated in FIG. 5D, the controller 500 causes the third conveyance roller pair 6 to rotate in the reverse direction to start conveyance of the two-ply sheet PJ in the reverse direction in step S5 of the flowcharts in FIGS. 13A and 14. At this time, the fourth sensor 44 detects the gripped portion B of the two-ply sheet PJ (i.e., the one end of the two-ply sheet PJ, in other words, the leading end of the two-ply sheet PJ conveyed in the reverse direction) to convey the gripped portion B of the two-ply sheet PJ to the gripping position of the winding roller 20. Further, the controller 500 causes the movable conveyance guide plate 23 to move from the second position to the first position in accordance with the conveyance of the two-ply sheet PJ conveyed in the reverse direction, in step S31 in the flowchart of FIG. 14.

Subsequently, the controller 500 determines whether the fourth sensor 44 has detected the gripped portion B of the two-ply sheet PJ, in step S6 of the flowchart in FIG. 13A. When the fourth sensor 44 has not detected the gripped portion B (NO in step S6 of FIG. 13A), step S6 is repeated until the fourth sensor 44 detects the gripped portion B of the two-ply sheet PJ. In contrast, when the fourth sensor 44 has detected the gripped portion B (YES in step S6 of FIG. 13A), as illustrated in FIG. 6A, in response to the detection of the gripped portion B of the two-ply sheet PJ by the fourth sensor 44, the controller 500 causes the third conveyance roller pair 6 to convey the two-ply sheet PJ by a predetermined amount X2 until the gripped portion B of the two-ply sheet PJ reaches the predetermined rotational position of the winding roller 20, in other words, the winding start position W (see FIG. 2). Then, the controller 500 causes the third conveyance roller pair 6 to stop the conveyance of the two-ply sheet PJ, in step S7 of the flowchart in FIG. 13A.

Then, as illustrated in FIG. 6B, the gripper 32 is moved from the releasing position to the gripping position while the gripped portion B of the two-ply sheet PJ is at the predetermined rotational position of the winding roller 20 (i.e., the winding start position W), in step S8 of the flowchart in FIG. 13A. In other words, the controller 500 causes the cam 34 to rotate to the position at which the cam 34 does not press the arm 31. While the cam 34 is at the position, as illustrated in FIG. 6B′, the end face of the one end of the two-ply sheet PJ does not contact any member, and the gripped portion B of the two-ply sheet PJ is gripped between the gripper 32 and the receiving portion 20b of the winding roller 20. The winding start position W illustrated in FIG. 2 is the predetermined position of the outer circumferential face of the winding roller 20 at the predetermined rotational position of the winding roller 20. However, at the releasing position in FIG. 6A and the gripping position in FIG. 6B, the outer circumferential face of the winding roller 20 does not exist. For this reason, the winding start position W is a position on a theoretical outer circumferential face of the winding roller 20.

Then, as illustrated in FIG. 6C, the winding roller 20 rotates in the reverse direction (that is, the counterclockwise direction in FIG. 6C) while the gripper 32 grips the two-ply sheet PJ, and the third conveyance roller pair 6 rotates again in the reverse direction together with the winding roller 20, in step S9 in the flowcharts of FIGS. 13A and 14. Further, as the winding roller 20 starts to wind the two-ply sheet PJ, as illustrated in FIG. 6C, the controller 500 causes the movable conveyance guide plate 23 to move from the first position to the second position, in step S32 in the flowchart of FIG. 14.

Then, as the winding roller 20 continues to rotate, the gap C is formed between the first sheet P1 and the second sheet P2 of the two-ply sheet PJ between the winding roller 20 and the third conveyance roller pair 6, as illustrated in FIG. 6D. As the gap C is formed, the first guide 25 and the movable conveyance guide plate 23 (at the second position) limit the warp (slack) of the two-ply sheet PJ in the vicinity of the winding roller 20. As a result, the gap C of the two-ply sheet PJ is intensively formed near the third conveyance roller pair 6.

As described above, the leading end of the two-ply sheet PJ in the reverse direction is detected by the fourth sensor 44 that is disposed between the third conveyance roller pair 6 and the winding roller 20 and downstream from the third conveyance roller pair 6 in the reverse direction. Since the controller 500 determines the timing at which the gripper 32 and the receiving portion 20b grip the gripped portion B of the two-ply sheet PJ in response to the timing of detection of the leading end of the two-ply sheet PJ conveyed in the reverse direction by the fourth sensor 44, the gripped portion B of the two-ply sheet PJ can be accurately conveyed to a desired gripping position regardless of variations in the sheet lengths with respect to the sheet conveyance amount X2 as the predetermined amount X2. Note that the size of sheets includes an error even if the sheets are sold as the same size.

Further, the fourth sensor 44 is disposed between the third conveyance roller pair 6 and the winding roller 20 at the position proximate to the winding roller 20. By so doing, the sheet conveyance amount X2 from the detection of the leading end of the two-ply sheet PJ in the reverse direction can be reduced regardless of the sheet length. As a result, the above-described configuration can reduce variation in the sheet conveyance amount X2 (i.e., the predetermined amount X2) and can accurately convey the gripped portion B of the two-ply sheet PJ to the desired gripping position.

Accordingly, the fourth sensor 44 is preferably disposed at the position near the winding roller 20.

Then, the controller 500 causes the third conveyance roller pair 6 to continue to rotate in the reverse direction and the winding roller 20 to start winding the two-ply sheet PJ, as illustrated in FIG. 6D. At the timing at which the third conveyance roller pair 6 has conveyed the two-ply sheet PJ by a conveyance amount that is equal to a predetermined amount X3 since the start of winding of the two-ply sheet PJ by the winding roller 20, the controller 500 causes the third conveyance roller pair 6 to stop the conveyance of the two-ply sheet PJ and the winding roller 20 to stop the winding the two-ply sheet PJ, as illustrated in FIG. 7A, in step S9 in the flowcharts of FIGS. 13A and 14. While the conveyance and winding of the two-ply sheet PJ are stopped, the two-ply sheet PJ is wound around the winding roller 20 one or more times, and the gap C in the two-ply sheet PJ (i.e., the distance between the first sheet P1 and the second sheet P2 in the vertical direction) is sufficiently widened. In other words, the bonding portion A of the two-ply sheet PJ is nipped by the third conveyance roller pair 6.

As a result, as illustrated in FIG. 7B, the controller 500 causes the separation members 16 to move from the retracted position to be inserted into the gap C (the insertion position in FIG. 11B) that is sufficiently widened in the two-ply sheet PJ, as illustrated in FIG. 7B, in step S10 in the flowcharts of FIGS. 13A and 14. In other words, as illustrated in FIGS. 10, 11A, and 11B, each of the separation members 16 in pair is moved from the retracted position in FIG. 11A to the separation position in FIG. 11B. At this time, as illustrated in FIG. 7B, the movable conveyance guide plate 23 is moved from the second position to the first position, in step S33 in the flowchart of FIG. 14.

Then, as illustrated in FIG. 7C, the third conveyance roller pair 6 and the winding roller 20 start rotating in the forward direction, in other words, in the clockwise direction while the separation members 16 are inserted in the gap C, in step S11 in the flowcharts of FIGS. 13A and 14.

At this time, when the winding roller 20 can convey the two-ply sheet PJ along with rotation of the winding roller 20 in the forward direction (i.e., the clockwise direction), the bonding portion A of the two-ply sheet PJ may not be nipped by the third conveyance roller pair 6. In other words, as the winding roller 20 rotates in the forward direction, the bonding portion A of the two-ply sheet PJ may be conveyed toward the third conveyance roller pair 6. Then, the third conveyance roller pair 6 may convey the two-ply sheet PJ while nipping the bonding portion A of the two-ply sheet PJ.

Then, as illustrated in FIG. 8A, the controller 500 causes the third conveyance roller pair 6 and the winding roller 20 to stop rotating in the forward direction after the third conveyance roller pair 6 has conveyed the two-ply sheet PJ in the forward direction by a predetermined amount X4, in step S12 of FIG. 13B. At this time, the two-ply sheet PJ is not wound around the gripper 32 and the gripper 32 can release the gripping of the gripped portion B of the two-ply sheet PJ at the winding start position W. In other words, at the winding start position W, the gripper 32 can move from the gripping position at which the gripper 32 grips the gripped portion B of the two-ply sheet PJ to the releasing position.

Then, the gripper 32 is moved from the gripping position to the releasing position while the two-ply sheet PJ is not wound around the gripper 32, so that the gripper 32 is on the third sheet conveyance passage K3, in step S13 of FIG. 13B. In other words, the cam 34 rotates as illustrated in FIG. 2B to move to the position at which the cam 34 presses the arm 31. The gripper 32 releases gripping the two-ply sheet PJ. In the present embodiment, the cam 34 in the movement mechanism 30 moves to release the gripping of the two-ply sheet PJ by the gripper 32. However, when the pulling force by conveyance of the two-ply sheet PJ by the third conveyance roller pair 6 is greater than the gripping force of the gripper 32 to grip the two-ply sheet PJ, the gripping of the two-ply sheet PJ by the gripper 32 can be released by pulling the two-ply sheet PJ from the gripper 32 due to conveyance of the two-ply sheet PJ by the third conveyance roller pair 6 without moving the cam 34 in the movement mechanism 30.

Then, as illustrated in FIG. 8B, the controller 500 causes the third conveyance roller pair 6 to rotates in the forward direction again to start conveyance of the two-ply sheet PJ in the forward direction, in step S14 in the flowchart of FIG. 13B. In response to the start of the conveyance of the two-ply sheet PJ in the forward direction, the fourth sensor 44 detects the gripped portion B of the two-ply sheet PJ, i.e., the one end of the two-ply sheet PJ and the trailing end of the two-ply sheet PJ conveyed in the forward direction. In addition, after the gripped portion B of the two-ply sheet PJ, i.e., the one end of the two-ply sheet PJ and the trailing end of the two-ply sheet PJ in the forward direction, passes over the switching members 15, the gripper 32 is moved from the retracted position to the gripping position and the switching members 15 are rotated in the clockwise direction from the standby position to the switching position.

Then, the controller 500 determines whether the third conveyance roller pair 6 conveys the two-ply sheet PJ by a predetermined amount X5 in response to the timing at which the fourth sensor 44 detects the trailing end of the two-ply sheet PJ conveyed in the forward direction, in other words, after the fourth sensor 44 has detected the gripped portion B of the two-ply sheet PJ, in step S15 in the flowchart of FIG. 13B. When the third conveyance roller pair 6 does not convey the two-ply sheet PJ by the predetermined amount X5 after the fourth sensor 44 has detected the gripped portion B of the two-ply sheet PJ (NO in step S15 of FIG. 13B), step S15 is repeated until the third conveyance roller pair 6 conveys the two-ply sheet PJ by the predetermined amount X5 after the fourth sensor 44 has detected the gripped portion B of the two-ply sheet PJ. In contrast, when the third conveyance roller pair 6 conveys the two-ply sheet PJ by the predetermined amount X5 and stops the conveyance of the two-ply sheet PJ in response to the timing at which the fourth sensor 44 detects the gripped portion B of the two-ply sheet PJ (the trailing end of the two-ply sheet PJ in the forward direction) (YES in step S15 of FIG. 13B), the controller 500 causes the separation members 16 to move from the insertion position of the two-ply sheet PJ (the position illustrated in FIG. 11B) to the widthwise center position of the two-ply sheet PJ (the position illustrated in FIG. 11C), in step S25 in the flowcharts of FIGS. 13B and 14. As a result, as illustrated in FIG. 8B, the trailing ends of the first sheet P1 and the second sheet P2 of the two-ply sheet PJ conveyed in the forward direction are separated and largely opened.

Then, as illustrated in FIG. 8C, the controller 500 causes the third conveyance roller pair 6 to rotate in the reverse direction to start conveyance of the two-ply sheet PJ in the reverse direction, and convey the first sheet P1 and the second sheet P2 of the two-ply sheet PJ separated from each other, to the first branched sheet conveyance passage K4 and the second branched sheet conveyance passage K5, respectively, in step S16 in the flowcharts of FIGS. 13B and 14. At this time, since the free ends of the switching members 15 are located at the switching position where the entry of the two-ply sheet PJ into the third sheet conveyance passage K3 is blocked, the two sheets, in other words, the first sheet P1 and the second sheet P2 separated from each other are guided to the first branched sheet conveyance passage K4 and the second branched sheet conveyance passage K5, respectively, as illustrated in FIG. 8C. At this time, the fifth sensor 45 (see FIG. 1) detects the bonding portion A of the two-ply sheet PJ (i.e., the other end of the two-ply sheet PJ and the trailing end of the two-ply sheet PJ conveyed in the reverse direction) so as to convey and stop the two-ply sheet PJ while the third conveyance roller pair 6 nips the portion near the bonding portion A of the two-ply sheet PJ.

At this time, since the movable conveyance guide plate 23 is located at the first position, the conveyance of the two sheets, which are the first sheet P1 and the second sheet P2 to the first branched sheet conveyance passage K4 and the second branched sheet conveyance passage K5, respectively, are not hindered, and do not interfere with the separation members 16.

Subsequently, as illustrated in FIG. 9A, in response to the timing at which the fifth sensor 45 (see FIG. 1) detects the trailing end of the two-ply sheet PJ conveyed in the reverse direction, that is, the bonding portion A of the two-ply sheet PJ in step S17 of FIG. 13B. Then, the controller 500 causes the third conveyance roller pair 6 to convey the two-ply sheet PJ by a predetermined amount X6 and stop, in step S18 of FIG. 13B. At this time, the bonding portion A of the two-ply sheet PJ is at the nipping position of the third conveyance roller pair 6 or a position slightly left and downstream from the nip region in the forward direction. In other words, the other end of the two-ply sheet PJ is nipped by the third conveyance roller pair 6.

Then, as illustrated in FIGS. 9A and 9B, the controller 500 causes the separation members 16 to move (retract) to the retracted position, in step S26 in the flowcharts of FIGS. 13A and 14, and starts to convey the inner sheet PM from the second sheet tray 12 (see FIG. 1), in step S19 in the flowcharts of FIGS. 13B and 14. At this time, the third sensor 43 determines whether the third sensor 43 has detected the leading end of the inner sheet PM (i.e., the other end of the inner sheet PM and the leading end in the forward direction), in step S20 in the flowchart of FIG. 13. Further, as illustrated in FIG. 9B, the controller 500 causes the movable conveyance guide plate 23 to move from the first position to the second position in accordance with the conveyance of the inner sheet PM that is conveyed in the forward direction, in step S35 in the flowchart of FIG. 14.

Subsequently, as illustrated in FIG. 9C, in response to the timing at which the third sensor 43 detects the leading end of the inner sheet PM in the forward direction (YES in step S20 in the flowchart of FIG. 13B), the controller 500 causes the second conveyance roller pair 5 to convey the inner sheet PM by the predetermined amount X7, and then causes the third conveyance roller pair 6 to start the conveyance of the two-ply sheet PJ in the forward direction again (step S21 in the flowcharts of FIGS. 13B and 14). At this time, the inner sheet PM is accurately nipped at a desired position between the first sheet P1 and the second sheet P2 of the two-ply sheet PJ. Further, the controller 500 causes the movable conveyance guide plate 23 to move from the second position to the first position, in step S36 in the flowchart of FIG. 14.

Thus, the controller 500 finishes the operations to insert the inner sheet PM between the first sheet P1 and the second sheet P2 in the two-ply sheet PJ. Accordingly, the third conveyance roller pair 6 conveys the two-ply sheet PJ in the forward direction with the inner sheet PM being inserted in the two-ply sheet PJ, so that the two-ply sheet PJ with the inner sheet PM is placed on the ejection tray 13 (see FIG. 1).

In the present embodiment, when the two-ply sheet PJ is conveyed as illustrated in FIG. 7A of the present embodiment, the gap C is formed between the first sheet P1 and the second sheet P2 of the two-ply sheet PJ in the non-bonding portion near the bonding portion A of the two-ply sheet PJ to peel (separate) the two sheets, i.e., the first sheet P1 and the second sheet P2.

In contrast, when the two-ply sheet PJ is conveyed as illustrated in FIG. 7A of the present embodiment, the bonding portion A of the two-ply sheet PJ may be set as the gripped portion B if the two-ply sheet PJ is gripped by the third conveyance roller pair 6 with sufficiently strong force. In other words, in FIGS. 6A, 6B, 6B′, 6C, 6C′, and 6D, while the bonding portion A of the two-ply sheet PJ is gripped by the gripper 32 and the receiving portion 20b of the winding roller 20, the two-ply sheet PJ is wound around the winding roller 20, and the non-bonding portion is nipped and conveyed by the third conveyance roller pair 6. At this time, the third conveyance roller pair 6 rotates to convey the first sheet P1 and the second sheet P2 of the two-ply sheet PJ in sync with each other without slipping. For example, increasing the nip pressure of the third conveyance roller pair 6, using roller material having a large coefficient of friction, or controlling the driving method of the rollers of the third conveyance roller pair 6 reduces occurrence of slippage of the two sheets (i.e., the first sheet P1 and the second sheet P2). By so doing, a desired gap such as the gap C is formed in the two-ply sheet PJ to peel (separate) the two sheets (the first sheet P1 and the second sheet P2). The above-described configuration can also reduce the number of times of conveyance of the two-ply sheet PJ until the inner sheet PM is inserted into the two-ply sheet PJ.

### Modification 1

A description is given of a sheet laminator according to Modification 1, with reference to FIG. 16.

FIG. 16 is a diagram illustrating a sheet laminator according to Modification 5 of an embodiment of the present disclosure.

As illustrated in FIG. 16, a sheet laminator 50 according to Modification 1 includes the sheet separation device 1 illustrated in FIG. 1.

The sheet laminator 50 includes a sheet lamination unit 51 disposed downstream from the third conveyance roller pair 6 of the sheet separation device 1 in the forward direction. The sheet lamination unit 51 performs a sheet laminating operation on the two-ply sheet PJ in which the inner sheet PM is inserted between the first sheet P1 and the second sheet P2 that are separated by the sheet separation device 1.

The sheet lamination unit 51 includes multiple thermal pressure roller pairs to apply heat and pressure to the two-ply sheet PJ while conveying the two-ply sheet PJ in the forward direction with the inner sheet PM being inserted in the two-ply sheet PJ. After the two-ply sheet PJ has passed through the sheet lamination unit 51, the entire region of the two-ply sheet PJ is bonded while the inner sheet PM is inserted in the two-ply sheet PJ. Then, the two-ply sheet PJ on which the sheet laminating operation has been performed as described above is ejected to the outside of the sheet lamination unit 51 by an ejection roller pair 7 to be stacked on the ejection tray 13.

As described above, the sheet laminator 50 according to the first variation performs a process to feed the two-ply sheet PJ and the inner sheet PM, a process to separate the two sheets (the first sheet P1 and the second sheet P2) in the two-ply sheet PJ, a process to insert the inner sheet PM into the space between the two separated sheets P1 and P2, and a process to perform the laminating process on the two-ply sheet PJ in which the inner sheet PM is inserted, as a sequence of processes, thus enhancing the convenience for a user.

In particular, once the leading end face of the two-ply sheet PJ is damaged, it is difficult to perform the sheet laminating operation on the damaged leading end face. For this reason, the configuration of the present disclosure is useful.

The sheet laminator 50 included in the image forming system 200 according to Modification 1 of an embodiment of the present disclosure also includes the movable conveyance guide plate 23 in the conveyance passage between the winding roller 20 and the third conveyance roller pair 6. Due to such a configuration, a conveyance failure of the two-ply sheet PJ or the inner sheet PM is less likely to occur in the conveyance passage.

### Modification 2

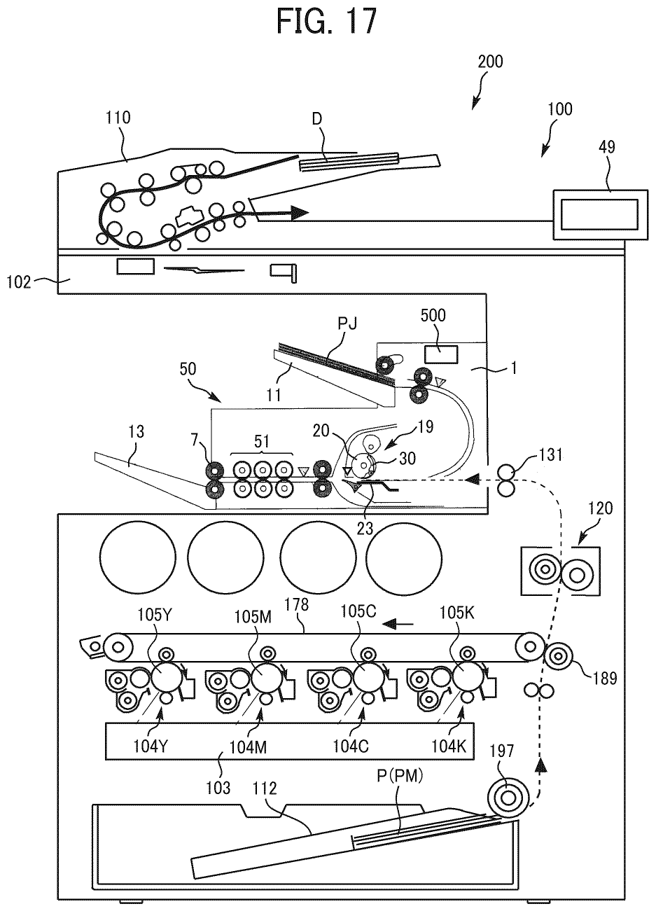

A description is given of an image forming system according to Modification 2, with reference to FIG. 17.

FIG. 17 is a diagram illustrating an image forming system according to Modification 6 of an embodiment of the present disclosure.

As illustrated in FIG. 17, an image forming system 200 according to Modification 2 includes an image forming apparatus 100 that forms an image on a sheet P and the sheet laminator 50 illustrated in FIG. 16, disposed on the image forming apparatus 100.

With reference to FIG. 17, in the image forming apparatus 100, multiple pairs of sheet conveyance rollers disposed in a document feeder 110 feed an original document D from a document loading table and convey the original document D in a direction indicated by arrow in FIG. 17. By so doing, the original document D passes over a document reading device 102. At this time, the document reading device 102 optically reads image data of the original document D while the original document D is passing over the document reading device 102.

The image data optically scanned by the document reading device 102 is converted into electrical signals. The electrical signals are then transmitted to a writing device 103. The writing device 103 emits laser beams onto the photoconductor drums 105Y, 105M, 105C, and 105K based on the electrical signals of the image data in each of colors, respectively, performing an exposing process.

In the image forming apparatus 100, a charging process, the exposing process, and a developing process are sequentially executed on the photoconductor drums 105Y, 105M, 105C, and 105K of respective image forming units 104Y, 104M, 104C, and 104K to form desired images on the photoconductor drums 105Y, 105M, 105C, and 105K, respectively.

The images formed on the photoconductor drums 105Y, 105M, 105C, and 105K are transferred and superimposed onto the intermediate transfer belt 178 to form a color image. The color image formed on the intermediate transfer belt 178 is further transferred onto the surface of a sheet P (which is to be the inner sheet PM) fed and conveyed from a feeding device 112 by a feed roller 197 at a position at which the intermediate transfer belt 178 faces a secondary transfer roller 189.

After the color image is transferred onto the surface of the sheet P (that is the inner sheet PM), the sheet P is conveyed to the position of a fixing device 120. The fixing device 120 fixes the transferred color image formed on the surface of the sheet P, to the sheet P.

The sheet P is then ejected from the image forming apparatus 100 by an ejection roller pair 131, and is fed as the inner sheet PM, into the sheet laminator 50. The sheet laminator 50 including the sheet separation device 1 has completed the process described with reference to FIGS. 5A to 8C (in other words, the process to separate the two-ply sheet PJ) by the time that the inner sheet PM is fed into the sheet laminator 50 (the sheet separation device 1). After the inner sheet PM has been inserted into the sheet laminator 50 (the sheet separation device 1), the process described with reference to FIGS. 9A to 9C (in other words, the process to insert the inner sheet PM into the two-ply sheet PJ) is performed. Further, after the sheet lamination unit 51 has completed the sheet laminating operation on the two-ply sheet PJ in which the inner sheet PM is inserted, the ejection roller pair 7 ejects the two-ply sheet PJ to the outside of the sheet lamination unit 51 to stack the two-ply sheet PJ on the ejection tray 13.

As described above, a series of image forming processes (i.e., the printing operations) performed by the image forming apparatus 100 included in the image forming system 200 and a series of sheet separating operation performed on the two-ply sheet P by the sheet laminator 50 and the sheet laminating operation performed on the inner sheet PM by the sheet laminator 50 after the image is formed on the inner sheet PM by the image forming apparatus 100 are completed.

In Modification 2, the image forming system 200 includes the image forming apparatus 100 and the sheet laminator 50 disposed on the image forming apparatus 100. However, the image forming system 200 may include the image forming apparatus 100 and the sheet separation device 1 illustrated in FIG. 1 with the sheet separation device 1 being disposed on the image forming apparatus 100.

Further, the image forming apparatus 100 according to Modification 2 of the present disclosure is a color image forming apparatus but may be a monochrome image forming apparatus. The image forming apparatus 100 according to Modification 2 of the present disclosure employs electrophotography, but the present disclosure is not limited to an electrophotographic image forming apparatus. For example, the present disclosure may be applied to other types of image forming apparatuses such as an inkjet image forming apparatus and a stencil printing machine.

The sheet laminator 50 included in the image forming system 200 according to Modification 2 of an embodiment of the present disclosure also includes the movable conveyance guide plate 23 in the conveyance passage between the winding roller 20 and the third conveyance roller pair 6. Due to such a configuration, a conveyance failure of the two-ply sheet PJ or the inner sheet PM is less likely to occur in the conveyance passage.

### Modification 3

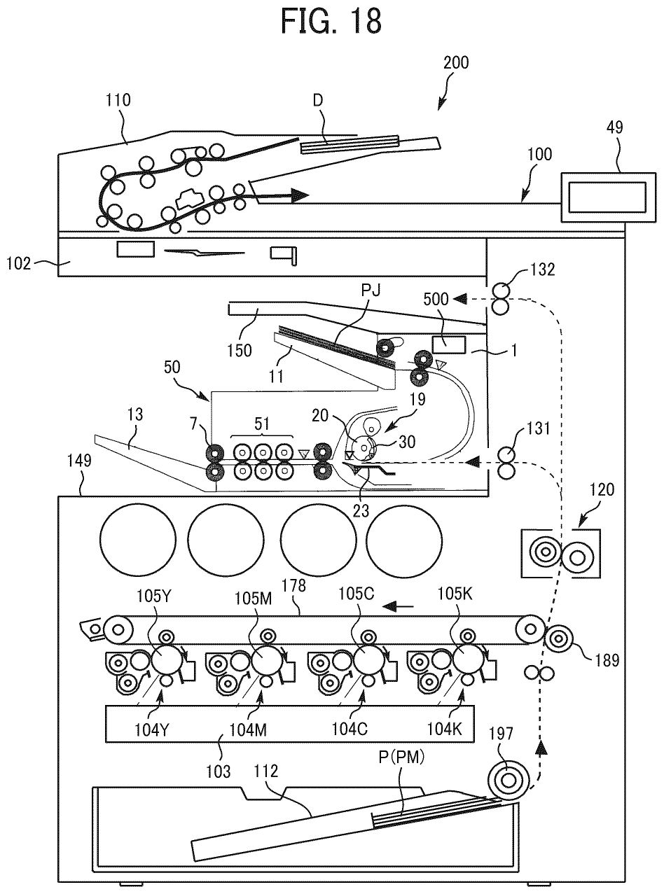

A description is given of an image forming system according to Modification 3, with reference to FIG. 18.

FIG. 18 is a diagram illustrating an image forming system according to Modification 3 of an embodiment of the present disclosure.

As illustrated in FIG. 18, an image forming system 200 according to Modification 3 includes the image forming apparatus 100 illustrated in FIG. 17 that forms an image on a sheet P, and the sheet laminator 50 illustrated in FIG. 16 that is detachably attached to the image forming apparatus 100 of the image forming system 200.

In the image forming system 200 illustrated in FIG. 18, the image forming apparatus 100 performs the image forming processes on the sheet P, as described above with reference to FIG. 16. Then, the image forming apparatus 100 ejects the sheet P (that is, the inner sheet PM on which a desired image is formed) by the ejection roller pair 131 from the image forming apparatus 100 to the sheet laminator 50. After the sheet P is conveyed to the sheet laminator 50, the sheet P is inserted into the two-ply sheet PJ, where the sheet laminator 50 performs the sheet laminating operation on the two-ply sheet PJ. Then, the ejection roller pair 7 ejects the two-ply sheet PJ to the outside of the sheet laminator 50 to stack the two-ply sheet PJ on the ejection tray 13.

When the user selects a mode not to perform such a sheet laminating operation as described above, the sheet P on which an image is formed through the image formation process in the image forming apparatus 100 of the image forming system 200 is ejected by a second ejection roller pair 132 to the outside of the image forming apparatus 100 to be stacked on a second ejection tray 150.

As described above, the sheet laminator 50 is detachably attached to the image forming apparatus 100. When the sheet laminator 50 is not used, the sheet laminator 50 may be detached from the image forming apparatus 100 of the image forming system 200. When the sheet laminator 50 is detached from the image forming apparatus 100, a placement surface 149 on which the sheet laminator 50 was installed functions as an ejection tray. For example, when the sheet P is ejected from the ejection roller pair 131 to the outside of the image forming apparatus 100, the sheet P on which a desired image is formed is stacked on the placement surface 149.

In Modification 3, the sheet laminator 50 is detachably attached to the image forming system 200. However, the sheet separation device 1 illustrated in FIG. 1 may be detachably attached to the image forming system 200.

The sheet laminator 50 included in the image forming system 200 according to Modification 3 of an embodiment of the present disclosure also includes the movable conveyance guide plate 23 in the conveyance passage between the winding roller 20 and the third conveyance roller pair 6. Due to such a configuration, a conveyance failure of the two-ply sheet PJ or the inner sheet PM is less likely to occur in the conveyance passage.

A description is given of an image forming system according to another embodiment of the present disclosure.

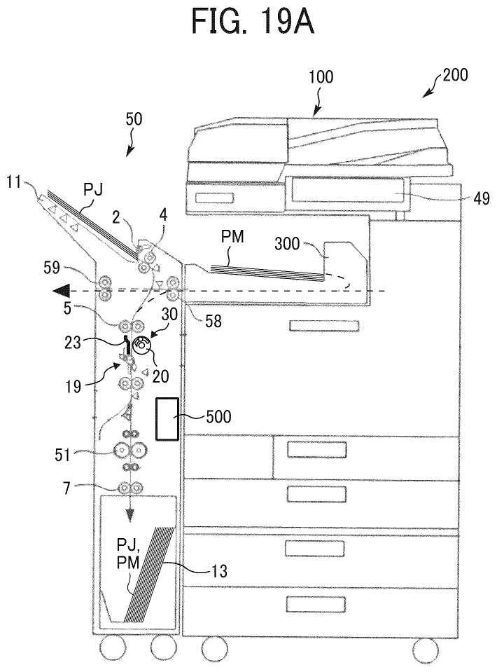

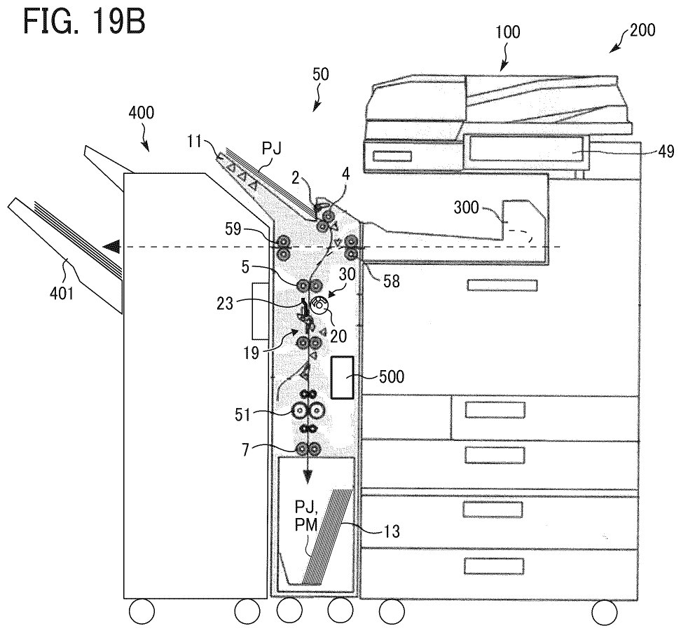

FIG. 19A is a diagram illustrating an image forming system, according to another embodiment of the present disclosure.

The image forming system 200 according to Modification 3 includes the sheet laminator 50 in a space below the document feeder 110 of the image forming apparatus 100 and detachably attached to the image forming apparatus 100 of the image forming system 200.

In contrast, like the image forming system 200 illustrated in FIG. 19A, the sheet laminator 50 may be detachably attached adjacent to the image forming apparatus 100, in other words, the sheet laminator 50 may be detachably attached to the image forming apparatus 100 on the side to which the sheet P having an image on the surface is ejected. In such a configuration of the sheet laminator 50, the first sheet tray 11 on which the two-ply sheets PJ are stacked, the sheet separation unit 19 (winding roller 20), the sheet lamination unit 51, and the ejection tray 13 are sequentially disposed in this order from top to bottom in the vertical direction. In addition to the sheet conveyance passage used to guide the inner sheet PM ejected from the image forming apparatus 100 to the sheet separation unit 19 (winding roller 20), the sheet laminator 50 may be provided with another sheet conveyance passage (defined by sheet conveyance roller pairs 58 and 59) used to eject the sheet P ejected from the image forming apparatus 100 without the sheet laminating operation on the sheet P.

The image forming system 200 may also be provided with a relay device 300 that guides the sheet P (including the inner sheet PM) ejected from the image forming apparatus 100 to the sheet laminator 50.

In this case, the inner sheet PM may be fed from the relay device 300.

Further, FIG. 19B is a schematic view of the image forming system 200 according to yet another embodiment of the present disclosure.

As the image forming system 200 illustrated in FIG. 19B, a post-processing apparatus 400 may be provided to perform the post-processing operations including the punching operation and the stapling operation, on the sheet P ejected from the image forming apparatus 100 through the sheet laminator 50 (or the sheet P without the sheet laminating operation). In such a case, the sheet P is ejected to an ejection tray 401 of the post-processing apparatus 400 after the post-processing operation has been performed on the sheet P.

As described above, the sheet separation device 1 according to the present embodiment includes the sheet separation unit 19 that performs the sheet separating operation and the sheet inserting operation. More specifically, the sheet separation unit 19 of the sheet separation device 1 performs the sheet separating operation to separate the non-bonding portion of the two-ply sheet PJ in which two sheets, which are the first sheet P1 and the second sheet P2, are overlapped and bonded together at one end of the two-ply sheet PJ as the bonding portion A of the two-ply sheet PJ. The sheet separation unit 19 of the sheet separation device 1 then performs the sheet inserting operation to insert the inner sheet PM between the first sheet P1 and the second sheet P2 separated from each other in the sheet separating operation. Further, the third conveyance roller pair (conveyance roller pair) that can convey the two-ply sheet PJ in the forward and reverse directions, where the conveyance direction from the sheet separation unit 19 is the forward direction and the sheet conveyance direction to the sheet separation unit 19 is the reverse direction. The sheet separation unit 19 includes the winding roller 20 that rotates in a given rotational direction to wind the two-ply sheet PJ, and the separation members 16 (separation member) to move from the retracted position where the conveyance of the two-ply sheet PJ or the inner sheet PM is not hindered, between the winding roller 20 and the third conveyance roller pair 6, to be inserted into the gap C formed between the first sheet P1 and the second sheet P2. Moreover, the two branched sheet conveyance passages K4 and K5 that branch in separate sheet conveyance directions, from the third sheet conveyance passage K3 between the winding roller 20 and the third conveyance roller pair 6, interposed by the third sheet conveyance passage K3. Further, the movable conveyance guide plate 23 (movable conveyance guide) that can move in the forward and reverse directions in the third sheet conveyance passage K3 to guide the two-ply sheet PJ or the inner sheet PM.

Due to such a configuration, the conveyance failure of the two-ply sheet PJ and the inner sheet PM is less likely to occur in the conveyance passage between the winding roller 20 and the third conveyance roller pair 6.

The present disclosure is not limited to the above-described embodiment and variations, and the configuration of the present embodiment can be appropriately modified other than suggested in the above embodiment and variations within a scope of the technological concept of the present disclosure. Further, features of components of the embodiments, such as the number, the position, and the shape are not limited to the embodiments and thus may be preferably set to be applied to the present disclosure.

The present disclosure may be applicable to, for example, a combination of the following aspects.

### Aspect 1

In Aspect 1, a sheet separation device includes a sheet separation unit, a conveyance roller pair, two branched conveyance passages, and a movable conveyance guide. The sheet separation unit separates a non-bonding portion of a two-ply sheet having two sheets overlapped and bonded together at a bonding portion in a conveyance direction in which the two-ply sheet is conveyed, and inserts an inner sheet between the two sheets separated from each other. The conveyance roller pair rotates the two-ply sheet in a first direction (for example, the forward direction) that is the conveyance direction from the sheet separation unit and a second direction (for example, the reverse direction) that is the conveyance direction to the sheet separation unit and is opposite to the first direction. The sheet separation unit includes a winding roller and a separator. The winding roller rotates in a given rotational direction to wind the two-ply sheet. The separator is disposed between the winding roller and the conveyance roller pair. The separator moves from a retracted position that allows a smooth conveyance of the two-ply sheet or the inner sheet, so as to be inserted to a space between the two sheets separated from each other. The two branched conveyance passages that branch in separate directions from a conveyance passage between the winding roller and the conveyance roller pair, across the conveyance passage. The movable conveyance guide is movable in the first direction and the second direction in the conveyance passage to guide the two-ply sheet or the inner sheet.

### Aspect 2

In Aspect 2, the sheet separation device according to Aspect 1 further includes circuitry to control a movement of the movable conveyance guide. The movable conveyance guide is disposed at a position opposite to a position of the winding roller, across the conveyance passage, and the circuitry is further to move the movable conveyance guide between a first position and a second position, where the first position is in a first conveyance guide range from the winding roller to an upstream side of the separator in the first direction in the conveyance passage, and the second position is in a second conveyance guide range from the upstream side of the separator in the first direction to the conveyance roller pair in the conveyance passage.

### Aspect 3

In Aspect 3, in the sheet separation device according to Aspect 2, the circuitry is further to move the movable conveyance guide from the first position to the second position, according to a conveyance of the two-ply sheet in the first direction in the conveyance passage, when the separator is at the retracted position.

### Aspect 4

In Aspect 4, the sheet separation device according to Aspect 2 or 3, the circuitry is further to move the movable conveyance guide from the second position to the first position, according to a conveyance of the two-ply sheet in the second direction in the conveyance passage, when the separator is at the retracted position.

### Aspect 5

In Aspect 5, in the sheet separation device according to any one of Aspects 2 to 4, the movable conveyance guide is at the first position when the two-ply sheet is conveyed in the first direction or the second direction in the conveyance passage, from the retracted position to be inserted to the space between the two sheets separated from each other.

### Aspect 6

In Aspect 6, in the sheet separation device according to any one of Aspects 2 to 5, the circuitry is further to move the movable conveyance guide from the first position to the second position, according to a conveyance of the inner sheet in the first direction in the conveyance passage, when the separator is inserted to the two-ply sheet, between the two sheets separated from each other in the two branched conveyance passages.

### Aspect 7

In Aspect 7, in the sheet separation device according to Aspect 6, the circuitry is further to move the movable conveyance guide from the second position to the first position, when the two-ply sheet is conveyed in the first direction by the conveyance roller pair with the inner sheet inserted between the two sheets of the two-ply sheet.

### Aspect 8

In Aspect 8, a sheet laminator includes the sheet separation device according to any one of Aspects 1 to 7, and a sheet lamination unit to perform a sheet laminating operation on the two-ply sheet having the inner sheet inserted between the two sheets separated by the sheet separation device.

### Aspect 9

In Aspect 9, an image forming system includes the sheet separation device according to any one of Aspects 1 to 7, and an image forming apparatus to form an image on the inner sheet.

### Aspect 10

In Aspect 10, an image forming system includes the sheet laminator according to Aspect 8, and an image forming apparatus to form an image on the inner sheet.

### Aspect 11

In Aspect 11, in the image forming system according to any one of Aspects 1 to 7, the sheet separation device is detachably attached to the image forming apparatus.

### Aspect 12

In Aspect 12, in the image forming system according to Aspect 8, the sheet laminator is detachably attached to the image forming apparatus.

### Aspect 13

In Aspect 13, a sheet separation device includes a sheet separation unit, a conveyance roller pair, branched conveyance passages, and a movable conveyance guide. The sheet separation unit includes a winding roller and a separator. The winding roller rotates in a given rotational direction to wind a two-ply sheet having two sheets overlapped and bonded together at a bonding portion. The separator separates a non-bonding portion of the two-ply sheet. The sheet separation unit inserts an inner sheet between the two sheets separated from each other. The conveyance roller pair conveys the two-ply sheet from the sheet separation unit along a conveyance passage in a first direction, and conveys the two-ply sheet toward the sheet separation unit along the conveyance passage in a second direction opposite to the first direction. The branched conveyance passages are branched from the conveyance passage in separate directions, and disposed between the winding roller and the conveyance roller pair across the conveyance passage. The movable conveyance guide is movable in the first direction and the second direction in the conveyance passage to guide the two-ply sheet or the inner sheet. The separator is disposed between the winding roller and the conveyance roller pair in the conveyance passage.

### Aspect 14

In Aspect 14, the sheet separation device according to Aspect 13 further includes circuitry to control a movement of the movable conveyance guide. The movable conveyance guide is disposed opposite the winding roller with the conveyance passage in between. The circuitry is further to move the movable conveyance guide between a first position and a second position, where the first position is in a first conveyance guide range from the winding roller to an upstream side of the separator in the first direction in the conveyance passage, and the second position is in a second conveyance guide range from the upstream side of the separator to the conveyance roller pair in the first direction in the conveyance passage.

### Aspect 15

In Aspect 15, in the sheet separation device according to Aspect 14, the circuitry is further to move the movable conveyance guide from the first position to the second position in sync with a conveyance of the two-ply sheet in the first direction in the conveyance passage, when the separator is at a retracted position away from the conveyance passage in a width direction orthogonal to the first direction and the second direction, and the two-ply sheet is conveyed in the first direction.

### Aspect 16

In Aspect 16, in the sheet separation device according to Aspect 14 or Aspect 15, the circuitry is further to move the movable conveyance guide from the second position to the first position in sync with a conveyance of the two-ply sheet in the second direction in the conveyance passage, when the separator is at a retracted position away from the conveyance passage in a width direction orthogonal to the first direction and the second direction, and the two-ply sheet is conveyed in the second direction.

### Aspect 17

In Aspect 17, in the sheet separation device according to Aspect 14, the movable conveyance guide is at the first position, when the two-ply sheet is conveyed in the first direction or the second direction in the conveyance passage, and the separator is moved from the retracted position, and inserted to a space between the two sheets of the two-ply sheet separated from each other.

### Aspect 18

In Aspect 18, in the sheet separation device according to Aspect 14, the circuitry is further to move the movable conveyance guide from the first position to the second position in sync with a conveyance of the inner sheet in the first direction in the conveyance passage, when the two sheets of the two-ply sheet are separated from each other at the branched conveyance passages in the conveyance passage, and the inner sheet is inserted between the two sheets of the two-ply sheet separated from each other.

### Aspect 19

In Aspect 19, in the sheet separation device according to Aspect 18, the circuitry is further to move the movable conveyance guide from the second position to the first position, when the two-ply sheet is conveyed in the first direction by the conveyance roller pair, with the inner sheet inserted between the two sheets of the two-ply sheet.

### Aspect 20

In Aspect 20, a sheet laminator includes the sheet separation device according to Aspect 13 or Aspect 14, and a sheet lamination unit to perform a sheet laminating operation on the two-ply sheet having the inner sheet inserted between the two sheets separated by the sheet separation device.

### Aspect 21

In Aspect 21, an image forming system includes the sheet laminator according to Aspect 20, and an image forming apparatus to form an image on the inner sheet.

### Aspect 22

In Aspect 22, in the image forming system according to Aspect 21, the sheet laminator is detachably attached to the image forming apparatus.

### Aspect 23

In Aspect 23, an image forming system includes the sheet separation device according to Aspect 13 or Aspect 14, and an image forming apparatus to form an image on the inner sheet.

### Aspect 24

In Aspect 24, in the image forming system according to Aspect 23, the sheet separation device is detachably attached to the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet separation device comprising:
a sheet separation unit including:
a winding roller to rotate in a given rotational direction to wind a two-ply sheet having two sheets overlapped and bonded together at a bonding portion; and
a separator to separate a non-bonding portion of the two-ply sheet,
the sheet separation unit to insert an inner sheet between the two sheets separated from each other;
a conveyance roller pair to:
convey the two-ply sheet from the sheet separation unit along a conveyance passage in a first direction; and
convey the two-ply sheet toward the sheet separation unit along the conveyance passage in a second direction opposite to the first direction,
branched conveyance passages:
branched from the conveyance passage in separate directions; and
disposed between the winding roller and the conveyance roller pair across the conveyance passage; and
a movable conveyance guide movable in the first direction and the second direction in the conveyance passage to guide the two-ply sheet or the inner sheet,
wherein the separator is disposed between the winding roller and the conveyance roller pair in the conveyance passage.

2. The sheet separation device according to claim 1, further comprising circuitry configured to control a movement of the movable conveyance guide,
wherein the movable conveyance guide is disposed opposite the winding roller with the conveyance passage in between, and
the circuitry is further configured to move the movable conveyance guide between a first position and a second position,
where the first position is in a first conveyance guide range from the winding roller to an upstream side of the separator in the first direction in the conveyance passage, and
the second position is in a second conveyance guide range from the upstream side of the separator to the conveyance roller pair in the first direction in the conveyance passage.

3. The sheet separation device according to claim 2,
wherein the circuitry is further configured to:
move the movable conveyance guide from the first position to the second position in sync with a conveyance of the two-ply sheet in the first direction in the conveyance passage,
when the separator is at a retracted position away from the conveyance passage in a width direction orthogonal to the first direction and the second direction, and
the two-ply sheet is conveyed in the first direction.

4. The sheet separation device according to claim 2,
wherein the circuitry is further configured to:
move the movable conveyance guide from the second position to the first position in sync with a conveyance of the two-ply sheet in the second direction in the conveyance passage,
when the separator is at a retracted position away from the conveyance passage in a width direction orthogonal to the first direction and the second direction, and
the two-ply sheet is conveyed in the second direction.

5. The sheet separation device according to claim 2,
wherein the movable conveyance guide is at the first position,
when the two-ply sheet is conveyed in the first direction or the second direction in the conveyance passage, and
the separator is:
moved from a retracted position; and
inserted to a space between the two sheets of the two-ply sheet separated from each other.

6. The sheet separation device according to claim 2,
wherein the circuitry is further configured to:
move the movable conveyance guide from the first position to the second position in sync with a conveyance of the inner sheet in the first direction in the conveyance passage,
when the two sheets of the two-ply sheet are separated from each other at the branched conveyance passages in the conveyance passage, and
the inner sheet is inserted between the two sheets of the two-ply sheet separated from each other.

7. The sheet separation device according to claim 6,
wherein the circuitry is further configured to:
move the movable conveyance guide from the second position to the first position,
when the two-ply sheet is conveyed in the first direction by the conveyance roller pair, with the inner sheet inserted between the two sheets of the two-ply sheet.

8. A sheet laminator comprising:
the sheet separation device according to claim 1; and
a sheet lamination unit to perform a sheet laminating operation on the two-ply sheet having the inner sheet inserted between the two sheets separated by the sheet separation device.

9. An image forming system comprising:
the sheet laminator according to claim 8; and
an image forming apparatus to form an image on the inner sheet.

10. The image forming system according to claim 9,
wherein the sheet laminator is detachably attached to the image forming apparatus.

11. An image forming system comprising:
the sheet separation device according to claim 1; and
an image forming apparatus to form an image on the inner sheet.

12. The image forming system according to claim 11,
wherein the sheet separation device is detachably attached to the image forming apparatus.
